(19) United States
(12) Patent Application Publication
(10) Pub. No.: US 2026/0296041 A1
(43) Pub. Date: Oct. 1, 2026

(54) LIQUID EJECTING APPARATUS AND LIQUID ACCOMMODATING DEVICE

(71) Applicant: SEIKO EPSON CORPORATION, Tokyo (JP)

(72) Inventor: Masahiko YOSHIDA, Shiojiri (JP)

(21) Appl. No.: 19/574,592

(22) Filed: Mar. 23, 2026

(30) Foreign Application Priority Data
Mar. 25, 2025 (JP) 2025-049731

(51) Int. Cl. B41J 2/175

(52) U.S. Cl. CPC B41J 2/17566; B41J 2/17513; B41J 2002/17579

(57) ABSTRACT

A liquid ejecting apparatus includes: an accommodating container that accommodates a conductive liquid; a first electrode; a second electrode; a cylindrical partition wall is provided to cover at least a part of the first electrode; a detection circuitry that is electrically coupled to the first electrode and the second electrode and outputs a detection signal corresponding; and a specifying circuitry that specifies an amount of remaining liquid accommodated in the accommodating container based on the detection signal, in which a first opening said one electrode is formed at an upper surface of the cylindrical partition wall, a second opening is formed at a lower surface, and when the liquid accommodated in the accommodating container is present at the first opening and the second opening, the first electrode and the second electrode are in contact with the liquid accommodated in the accommodating container.

The present application is based on, and claims priority from JP Application Serial Number 2025-049731, filed Mar. 25, 2025, the disclosure of which is hereby incorporated by reference herein in its entirety.

### BACKGROUND

### 1. Technical Field

The present disclosure relates to a liquid ejecting apparatus and a liquid accommodating device.

### 2. Related Art

Various techniques are proposed for detecting the amount of remaining liquid in an accommodating container for accommodating a conductive liquid such as an ink. For example, JP-A-6-270410 discloses a technique for detecting the amount of remaining liquid in an accommodating container based on a resistance value between two rod-shaped electrode pins provided in the accommodating container that accommodates the liquid.

Meanwhile, in the technique in the related art, since the change amount of the resistance value between the two electrode pins is small, as compared to the change amount of the amount of remaining liquid in the accommodating container, there are cases where it is difficult to detect the amount of remaining liquid in the accommodating container.

### SUMMARY

According to an aspect of the present disclosure, there is provided a liquid ejecting apparatus including: an accommodating container that accommodates a conductive liquid; a first electrode accommodated in the accommodating container; a second electrode accommodated in the accommodating container; a cylindrical partition wall that is accommodated in the accommodating container and is provided to cover at least a part of the first electrode; a detection circuitry that is electrically coupled to the first electrode and the second electrode and outputs a detection signal corresponding to an electric signal from one of the first electrode and the second electrode; and a specifying section that specifies an amount of remaining liquid accommodated in the accommodating container based on the detection signal, in which a first opening through which the first electrode is inserted is formed at an upper surface of the cylindrical partition wall, a second opening is formed at a lower surface of the cylindrical partition wall, and when the liquid accommodated in the accommodating container is present at the first opening and the second opening, the first electrode and the second electrode are in contact with the liquid accommodated in the accommodating container.

In addition, according to another aspect of the present disclosure, there is provided a liquid accommodating device including: an accommodating container that accommodates a conductive liquid; a first electrode accommodated in the accommodating container; a second electrode accommodated in the accommodating container; a cylindrical partition wall that is accommodated in the accommodating container and is provided to cover at least a part of the first electrode; and a detection circuitry that is electrically coupled to the first electrode and the second electrode and outputs a detection signal corresponding to an electric signal from one of the first electrode and the second electrode, in which a first opening through which the first electrode is inserted is formed at an upper surface of the cylindrical partition wall, a second opening is formed at a lower surface of the cylindrical partition wall, and when the liquid accommodated in the accommodating container is present at the first opening and the second opening, the first electrode and the second electrode are in contact with the liquid accommodated in the accommodating container.

### BRIEF DESCRIPTION OF THE DRAWINGS

FIG. 1 is a configuration diagram illustrating an example of an ink jet printer according to an embodiment of the present disclosure.

FIG. 2 is a perspective view illustrating an example of a configuration of an ink accommodating device.

FIG. 3 is a circuit diagram illustrating the example of the configuration of the ink accommodating device.

FIG. 4 is a cross-sectional view illustrating an example of a configuration of an ink tank.

FIG. 5 is a cross-sectional view illustrating an example of the configuration of the ink tank.

FIG. 6 is a plan view illustrating an example of the configuration of the ink tank.

FIG. 7 is a perspective view illustrating an example of the configuration of the ink tank.

FIG. 8 is a cross-sectional view illustrating an example of the configuration of the ink tank.

FIG. 9 is a circuit diagram illustrating an example of a configuration of an ink accommodating device according to Reference Example 1.

FIG. 10 is an explanatory diagram illustrating an example of a relationship between an ink liquid level distance and an ink resistance.

FIG. 11 is an explanatory diagram illustrating an example of a relationship between the ink liquid level distance and an output signal.

FIG. 12 is an explanatory diagram illustrating an example of a temperature change of a resistance value change curve.

FIG. 13 is an explanatory diagram illustrating an example of a temperature change of a potential change curve.

FIG. 14 is a circuit diagram illustrating an example of a configuration of an ink accommodating device according to Reference Example 2.

FIG. 15 is a cross-sectional view illustrating an example of a configuration of a flat plate partition wall according to Reference Example 2.

FIG. 16 is an explanatory diagram illustrating an example of a relationship between the ink liquid level distance and the ink resistance.

FIG. 17 is an explanatory diagram illustrating an example of a relationship between the ink liquid level distance and the output signal.

FIG. 18 is a circuit diagram illustrating an example of a configuration of an ink accommodating device according to Modification Example 1.

FIG. 19 is a timing chart illustrating an example of an operation of an ink amount detection circuit according to Modification Example 1.

FIG. 20 is a circuit diagram illustrating an example of a configuration of an ink accommodating device according to Modification Example 2.

FIG. 21 is a plan view illustrating an example of a configuration of an ink tank according to Modification Example 3.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and are thus added with technically preferred various limitations, but the scope of the present disclosure is not limited to such embodiments unless description for limiting the present disclosure is made in the following description.

### A. Embodiment

In the following, an ink jet printer 100 according to the present embodiment will be described.

### 1. Overview of Ink Jet Printer

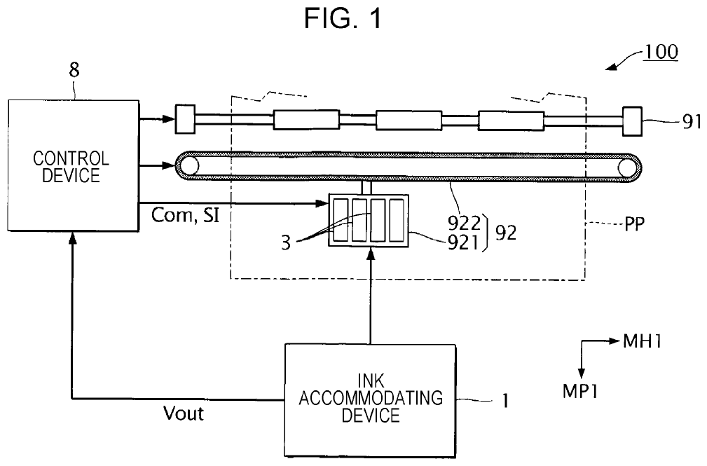

FIG. 1 is an explanatory diagram illustrating an example of a configuration of the ink jet printer 100 according to the present embodiment.

The ink jet printer 100 is an ink jet type printing apparatus that ejects an ink IK onto a medium PP. The medium PP is typically printing paper, but any print target, such as a resin film or fabric, may be used as the medium PP. In the present embodiment, a conductive ink is adopted as the ink IK.

In the present embodiment, the ink jet printer 100 is an example of a “liquid ejecting apparatus”, and the ink IK is an example of a “conductive liquid”.

As illustrated in FIG. 1, the ink jet printer 100 includes an ink accommodating device 1, a control device 8, a plurality of liquid ejecting heads 3, a transport mechanism 91, and a movement mechanism 92.

The control device 8 includes, for example, a processing circuit such as a CPU or FPGA and a storage circuit such as a semiconductor memory, and controls each element of the ink jet printer 100. Here, the CPU is an abbreviation for a central processing unit, and the FPGA is an abbreviation for a field programmable gate array.

The transport mechanism 91 transports the medium PP in a sub-scanning direction MP1 based on the control by the control device 8.

The movement mechanism 92 reciprocates the plurality of liquid ejecting heads 3 in a main scanning direction MH1 intersecting the sub-scanning direction MP1 and in a main scanning direction MH2 opposite to the main scanning direction MH1 based on the control by the control device 8. The movement mechanism 92 includes a storage case 921 that accommodates the plurality of liquid ejecting heads 3, and an endless belt 922 to which the storage case 921 is fixed. The storage case 921 may store the ink accommodating device 1, together with the liquid ejecting head 3.

The control device 8 supplies the liquid ejecting head 3 with a drive signal Com for driving the liquid ejecting head 3 and a control signal SI for controlling the liquid ejecting head 3.

The liquid ejecting head 3 is driven by the drive signal Com based on the control of the control signal SI to eject the ink IK from some or all of a plurality of nozzles provided in the liquid ejecting head 3. That is, the liquid ejecting head 3 ejects the ink IK from some or all of the plurality of nozzles in conjunction with the transport of the medium PP by the transport mechanism 91 and the reciprocation of the liquid ejecting head 3 by the movement mechanism 92, and lands the ejected ink onto a surface of the medium PP, thereby forming a desired image on the surface of the medium PP.

The ink accommodating device 1 accommodates the ink IK. Further, the ink accommodating device 1 supplies the ink IK accommodated in the ink accommodating device 1 to the liquid ejecting head 3 based on the control by the control device 8.

In the present embodiment, the ink accommodating device 1 is an example of a “liquid accommodating device”.

In the present embodiment, it is assumed that the ink accommodating device 1 accommodates M types of ink IK. Here, a value M is a natural number that satisfies 1≤M. More specifically, in the present embodiment, as an example, it is assumed that the ink accommodating device 1 accommodates four types of ink IK corresponding to cyan, magenta, yellow, and black. That is, in the present embodiment, as an example, “M=4” is assumed.

In the present embodiment, it is assumed that the ink jet printer 100 includes M liquid ejecting heads 3 corresponding to M types of ink IK. Specifically, in the present embodiment, as an example, it is assumed that the ink jet printer 100 includes four liquid ejecting heads 3 corresponding to four types of ink IK.

In the following, among the M liquid ejecting heads 3, the m-th liquid ejecting head 3 may be referred to as a liquid ejecting head 3[m]. Here, the variable m is a natural number that satisfies 1≤m≤M.

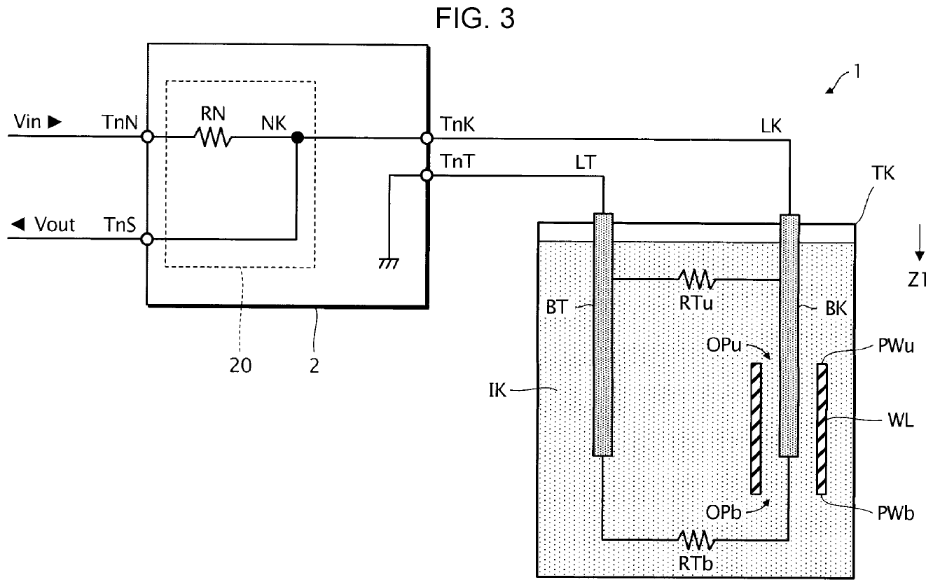

The ink accommodating device 1 includes an ink amount detection circuit 2 that detects the amount of various types of remaining ink IK accommodated in the ink accommodating device 1 and that outputs an output signal Vout indicating a result of the detection. The ink amount detection circuit 2 will be described later in FIG. 3.

In the present embodiment, the output signal Vout is an example of a “detection signal”.

### 2. Ink Accommodating Device

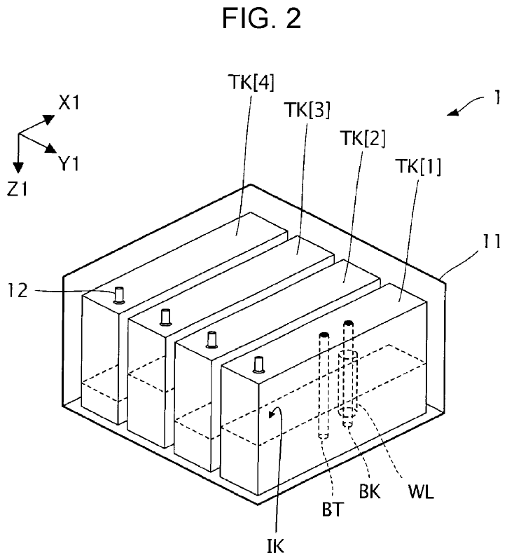

In the following, an overview of the ink accommodating device 1 will be described with reference to FIGS. 2 to 8.

FIG. 2 is a perspective view describing an example of a configuration of the ink accommodating device 1.

As illustrated in FIG. 2, the ink accommodating device 1 includes M ink tanks TK corresponding to one-to-one with the M types of inks IK accommodated in the ink accommodating device 1, and a storage case 11 that stores the M ink tanks TK. Specifically, in the present embodiment, the ink accommodating device 1 includes four ink tanks TK corresponding to one-to-one with four types of ink IK of cyan, magenta, yellow, and black.

In the present embodiment, the ink tank TK is an example of an “accommodating container”.

In the following, among the M ink tanks TK, the m-th ink tank TK may be referred to as an ink tank TK[m]. The ink tank TK[m] accommodates a type of ink IK corresponding to the ink tank TK[m], and supplies the ink IK to the liquid ejecting head 3[m] corresponding to the ink tank TK[m].

In the present embodiment, the ink tank TK is provided with a supply port 12 for supplying the ink IK to an internal space of the ink tank TK. In addition, the ink tank TK accommodates an electrode rod BT and an electrode rod BK, which are rod-shaped electrodes, and a cylindrical partition wall WL having a cylindrical shape provided to cover the electrode rod BK.

In the present embodiment, the electrode rod BK is an example of a “first electrode”, and the electrode rod BT is an example of a “second electrode”.

In the following, a direction in which the ink IK decreases in the ink tank TK when the ink IK is supplied from the ink tank TK to the liquid ejecting head 3 and the ink IK accommodated in the ink tank TK decreases is referred to as a Z1 direction. In the present embodiment, as an example, it is assumed that the electrode rod BT and the electrode rod BK are provided to extend in the Z1 direction in the ink tank TK.

Further, in the following, the Z1 direction and a Z2 direction opposite to the Z1 direction are collectively referred to as a Z-axis direction. In addition, hereinafter, an X1 direction intersecting the Z1 direction and an X2 direction opposite to the X1 direction are collectively referred to as an X-axis direction. In addition, hereinafter, a Y1 direction and a Y2 direction opposite to the Y1 direction, which intersect the Z1 direction and the X1 direction, are collectively referred to as a Y-axis direction. In the present embodiment, a case where the X-axis direction, the Y-axis direction, and the Z-axis direction are orthogonal to each other is assumed, but the present disclosure is not limited to such an aspect. The X-axis direction, the Y-axis direction, and the Z-axis direction may intersect each other.

In the present embodiment, the Z1 direction is an example of a “downward direction”, and the Z2 direction is an example of an “upward direction”.

FIG. 3 is a circuit diagram illustrating an example of a configuration of the ink accommodating device 1. In the present embodiment, it is assumed that the ink accommodating device 1 is provided with M ink amount detection circuits 2 that correspond one-to-one to the M ink tanks TK[1] to TK[M].

In the present embodiment, the ink amount detection circuit 2 is an example of a “detection circuitry”.

As illustrated in FIG. 3, the ink amount detection circuit 2 includes an output circuit 20, an input terminal TnN, a detection terminal TnK, a reference potential coupling terminal TnT, and an output terminal TnS.

The output circuit 20 includes a node NK and an input resistor RN provided between the input terminal TnN and the node NK.

The node NK is electrically coupled to the input terminal TnN, the detection terminal TnK, and the output terminal TnS. The detection terminal TnK is electrically coupled to the electrode rod BK via a detection wiring LK. The reference potential coupling terminal TnT is electrically coupled to a ground wiring set to a ground potential, and is electrically coupled to the electrode rod BT via a reference potential coupling wiring LT.

As described above, the ink tank TK accommodates the electrode rod BT, the electrode rod BK, and the cylindrical partition wall WL.

The cylindrical partition wall WL has a cylindrical shape, and is accommodated in the ink tank TK to cover a part of the electrode rod BK. In the following, among openings of the cylindrical partition wall WL, an opening formed at an upper surface PWu located at an end portion of the cylindrical partition wall WL in the Z2 direction (upward direction) is referred to as an upper opening OPu, and an opening formed at a lower surface PWb located at an end portion of the cylindrical partition wall WL in the Z1 direction (downward direction) is referred to as a lower opening OPb. The electrode rod BK is inserted through the upper opening OPu.

In the present embodiment, the upper opening OPu is an example of a “first opening”, and the lower opening OPb is an example of a “second opening”.

In the present embodiment, when the inks IK are accommodated in the ink tank TK and the electrode rod BT and the electrode rod BK are in contact with the inks IK accommodated in the ink tank TK, the electrode rod BT and the electrode rod BK are electrically coupled to each other via the inks IK accommodated in the ink tank TK.

Hereinafter, when the electrode rod BT and the electrode rod BK are electrically coupled to each other via the ink IK that is present in the lower opening OPb among the inks IK accommodated in the ink tank TK, an electric resistance of the ink IK that electrically couples the electrode rod BT and the electrode rod BK via the lower opening OPb is referred to as an ink resistance RTb. In addition, in the following, when the electrode rod BT and the electrode rod BK are electrically coupled to each other via the ink IK that is present in the upper opening OPu of the ink tank TK among the inks IK accommodated in the ink tank TK, an electric resistance of the ink IK that electrically couples the electrode rod BT and the electrode rod BK via the upper opening OPu is referred to as an ink resistance RTu.

In the present embodiment, an input signal Vin set to a constant input potential VN is input to the input terminal TnN. Therefore, when the electrode rod BT and the electrode rod BK are electrically coupled to each other via the ink IK accommodated in the ink tank TK, a potential of the node NK is determined based on the input potential VN of the input signal Vin, a resistance value of the input resistor RN, and a resistance value of a combined resistance of the ink resistance RTu and the ink resistance RTb. In the present embodiment, the input potential VN of the input signal Vin and the resistance value of the input resistor RN are constant values, and thus the potential of the node NK is determined based on the resistance value of the combined resistance of the ink resistance RTu and the ink resistance RTb. Further, the output signal Vout indicating the potential of the node NK is output from the output terminal TnS.

In the present embodiment, the control device 8 specifies the amount of remaining ink IK accommodated in the ink tank TK based on the output signal Vout output by the output circuit 20.

In the present embodiment, the control device 8 is an example of a “specifying section”.

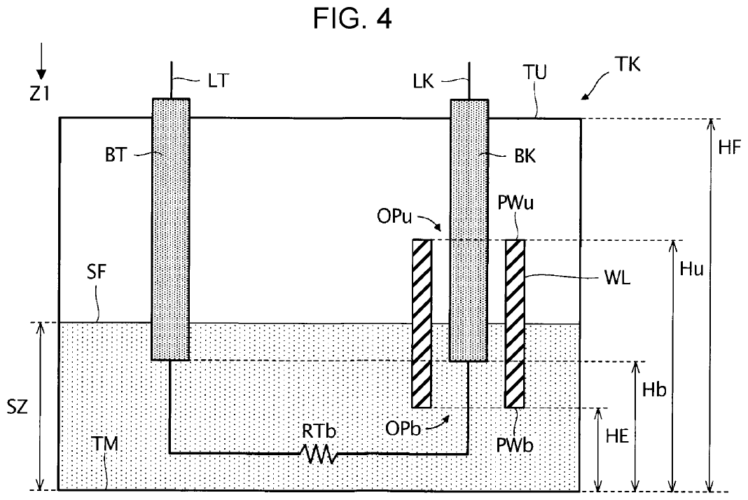

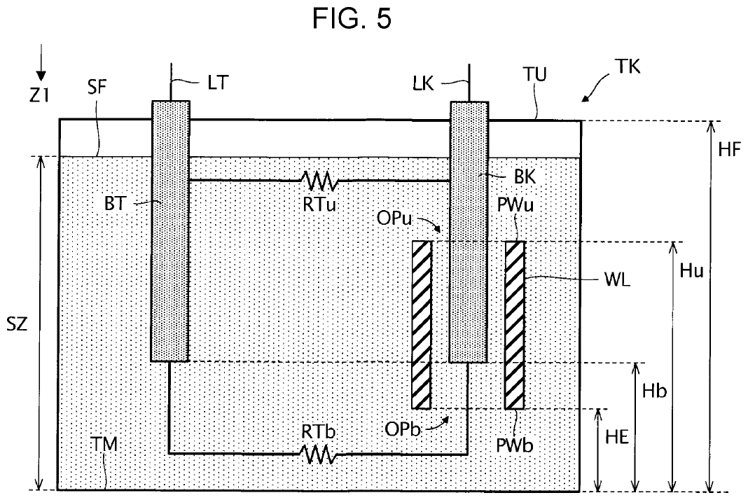

FIGS. 4 and 5 are configuration diagrams illustrating an example of a configuration of the ink tank TK.

As illustrated in FIGS. 4 and 5, the electrode rod BT is accommodated in the ink tank TK. The electrode rod BT is made of a conductive material, and is electrically coupled to the reference potential coupling wiring LT on an upper surface TU of the ink tank TK. The electrode rod BT is provided such that a distance in the Z-axis direction from an end portion of the electrode rod BT in the Z1 direction to a bottom surface TM of the ink tank TK is a distance Hb.

As illustrated in FIGS. 4 and 5, the electrode rod BK is accommodated in the ink tank TK. The electrode rod BK is made of a conductive material, and is electrically coupled to the detection wiring LK on the upper surface TU of the ink tank TK. The electrode rod BK is provided such that a distance in the Z-axis direction from an end portion of the electrode rod BK in the Z1 direction to the bottom surface TM of the ink tank TK is a distance Hb.

As illustrated in FIGS. 4 and 5, the cylindrical partition wall WL is accommodated in the ink tank TK. The cylindrical partition wall WL is made of an insulating material.

In the following, a distance in the Z-axis direction from the lower surface PWb, which is an end portion of the cylindrical partition wall WL in the Z1 direction, to the bottom surface TM of the ink tank TK is referred to as a distance HE, and a distance in the Z-axis direction from the upper surface PWu, which is an end portion of the cylindrical partition wall WL in the Z2 direction, to the bottom surface TM of the ink tank TK is referred to as a distance Hu. Further, a distance in the Z-axis direction from the upper surface TU of the ink tank TK to the bottom surface TM of the ink tank TK is referred to as a distance HF.

In the present embodiment, it is assumed that the distance HE is shorter than the distance Hb, that is, in the present embodiment, it is assumed that a lower end of the electrode rod BK is located between the upper surface PWu of the cylindrical partition wall WL and the lower surface PWb of the cylindrical partition wall WL in the Z-axis direction. In the present embodiment, it is assumed that a lower end of the electrode rod BT is located between the upper surface PWu of the cylindrical partition wall WL and the lower surface PWb of the cylindrical partition wall WL in the Z-axis direction.

In the present embodiment, the distance Hu is longer than the distance Hb and shorter than the distance HF.

In the present embodiment, a case is assumed in which the electrode rod BT and the electrode rod BK are provided such that the distance in the Z-axis direction from the bottom surface TM to the electrode rod BT and the distance in the Z-axis direction from the bottom surface TM to the electrode rod BK are both the distance Hb. However, the present disclosure is not limited to such an aspect. The electrode rod BT and the electrode rod BK may be provided such that the longer one of the distance from the bottom surface TM to the electrode rod BT in the Z-axis direction and the distance from the bottom surface TM to the electrode rod BK in the Z-axis direction is the distance Hb. In the present embodiment, a case where the distance Hb is longer than the distance HE is assumed, but the present disclosure is not limited to such an aspect. The distance Hb may be shorter than the distance HE.

Hereinafter, a distance in the Z-axis direction from the bottom surface TM of the ink tank TK to a liquid level SF of the ink IK accommodated in the ink tank TK is referred to as an ink liquid level distance SZ.

As illustrated in FIG. 4, when the ink liquid level distance SZ is equal to or greater than the distance Hb and less than the distance Hu, the inks IK are present at the lower opening OPb. When the ink liquid level distance SZ is equal to or greater than the distance Hb, the electrode rod BT and the electrode rod BK are electrically coupled by the ink IK that is present at the lower opening OPb. Therefore, when the ink liquid level distance SZ is equal to or greater than the distance Hb and smaller than the distance Hu, an electric resistance of the ink IK that electrically couples the electrode rod BT and the electrode rod BK is the ink resistance RTb.

As illustrated in FIG. 5, when the ink liquid level distance SZ is equal to or greater than the distance Hu, the inks IK are present in the lower opening OPb and the upper opening OPu. When the ink liquid level distance SZ is equal to or greater than the distance Hu, the electrode rod BT and the electrode rod BK are electrically coupled by the ink IK of the ink resistance RTb present in the lower opening OPb, and are electrically coupled by the ink IK of the ink resistance RTu present in the upper opening OPu. Therefore, when the ink liquid level distance SZ is equal to or greater than the distance Hu, an electric resistance of the ink IK that electrically couples the electrode rod BT and the electrode rod BK is a combined resistance of the ink resistance RTb and the ink resistance RTu when the ink resistance RTb and the ink resistance RTu are coupled in parallel.

In the following, the combined resistance of the ink resistance RTb and the ink resistance RTu is referred to as an ink resistance RG. That is, in the present embodiment, the resistor of the ink IK that electrically couples the electrode rod BT and the electrode rod BK is referred to as the ink resistance RG.

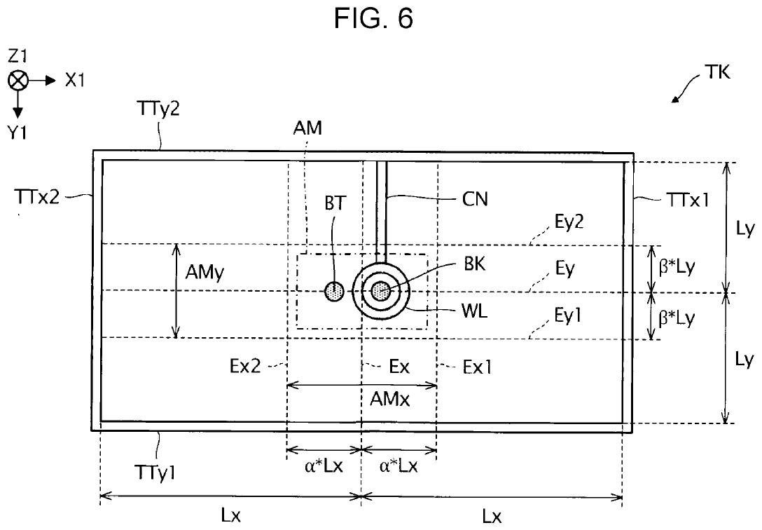

FIG. 6 is a plan view illustrating an example of a configuration of the ink tank TK.

As illustrated in FIG. 6, outer peripheries of the ink tank TK are defined by a side wall TTx1, a side wall TTx2, a side wall TTy1, and a side wall TTy2 when viewed in a plan view in the Z1 direction.

The side wall TTy1 is a side wall constituting an end portion of the ink tank TK in the Y1 direction. The side wall TTy1 is provided to extend on a plane with the Y-axis direction as a normal direction.

The side wall TTy2 constitutes an end portion of the ink tank TK in the Y2 direction, and is a side wall facing the side wall TTy1. The side wall TTy2 is provided to extend on a plane in which the Y-axis direction is a normal direction.

The side wall TTx1 is a side wall that constitutes an end portion of the ink tank TK in the X1 direction, and couples the side wall TTy1 and the side wall TTy2. The side wall TTx1 is provided to extend on a plane in which the X-axis direction is a normal direction.

The side wall TTx2 is a side wall that constitutes an end portion of the ink tank TK in the X2 direction, couples the side wall TTy1 and the side wall TTy2, and faces the side wall TTx1. The side wall TTx2 is provided to extend on a plane in which the X-axis direction is a normal direction.

In the present embodiment, the side wall TTy1 is an example of a “first side wall”, the side wall TTy2 is an example of a “second side wall”, the side wall TTx1 is an example of a “third side wall”, and the side wall TTx2 is an example of a “fourth side wall”.

In the following, for convenience of description, a center line Ey and a center line Ex will be introduced.

The center line Ey is a straight line indicating a center of the ink tank TK in the Y-axis direction when the ink tank TK is viewed in a plan view in the Z1 direction, and is a virtual straight line extending in the X-axis direction to be equidistant from the side wall TTy1 and the side wall TTy2.

The center line Ex is a straight line indicating a center of the ink tank TK in the X-axis direction when the ink tank TK is viewed in a plan view in the Z1 direction, and is a virtual straight line extending in the Y-axis direction to be equidistant from the side wall TTx1 and the side wall TTx2.

In the following, a distance between the center line Ey and the side wall TTy1 in the Y-axis direction and a distance between the center line Ey and the side wall TTy2 in the Y-axis direction are referred to as a distance Ly. Further, a distance between the center line Ex and the side wall TTx1 in the X-axis direction and a distance between the center line Ex and the side wall TTx2 in the X-axis direction are referred to as a distance Lx. In the present embodiment, as an example, it is assumed that the distance Lx is longer than the distance Ly.

In the present embodiment, the center line Ex is an example of a “first center portion”, and the center line Ey is an example of a “second center portion”.

Further, in the following, for convenience of description, a boundary line Ey1, a boundary line Ey2, a boundary line Ex1, and a boundary line Ex2 will be introduced.

The boundary line Ey1 is a straight line provided parallel to the center line Ey between the center line Ey and the side wall TTy1 when the ink tank TK is viewed in a plan view in the Z1 direction, and is a virtual straight line provided at a position at which a distance in the Y-axis direction from the center line Ey is B times the distance Ly. Here, the value B is a real number satisfying “0<β<0.5”, and more preferably, a real number satisfying “0<β≤0.2”.

The boundary line Ey2 is a straight line provided parallel to the center line Ey between the center line Ey and the side wall TTy2 when the ink tank TK is viewed in a plan view in the Z1 direction, and is a virtual straight line provided in a position at which a distance in the Y-axis direction from the center line Ey is B times the distance Ly.

The boundary line Ex1 is a straight line parallel to the center line Ex provided between the center line Ex and the side wall TTx1 when the ink tank TK is viewed in a plan view in the Z1 direction, and is a virtual straight line provided at a position at which a distance in the X-axis direction from the center line Ex is a times the distance Lx. Here, the value a is a real number satisfying “0<α<0.5”, and more preferably, a real number satisfying “0<α≤0.2”. In addition, the value a is preferably a real number satisfying “0<α<β”. The boundary line Ex2 is a straight line provided parallel to the center line Ex between the center line Ex and the side wall TTx2 when the ink tank TK is viewed in a plan view in the Z1 direction, and is a virtual straight line provided at a position at which a distance in the X-axis direction from the center line Ex is a times the distance Lx.

In addition, in the following, when the ink tank TK is viewed in a plan view in the Z1 direction, a region that overlaps the ink tank TK and is a region between the boundary line Ey1 and the boundary line Ey2 is referred to as a center region AMy. In addition, when the ink tank TK is viewed in a plan view in the Z1 direction, a region that overlaps the ink tank TK and is a region between the boundary line Ex1 and the boundary line Ex2 is referred to as a center region AMx. In addition, when the ink tank TK is viewed in a plan view in the Z1 direction, a region that overlaps the ink tank TK, is between the boundary line Ey1 and the boundary line Ey2, and is between the boundary line Ex1 and the boundary line Ex2 is referred to as a middle region AM.

In the present embodiment, the middle region AM is an example of a “middle portion”, the center region AMx is an example of a “region including a first center portion”, and the center region AMy is an example of a “region including a second center portion”.

In the present embodiment, it is assumed that the electrode rod BK, the electrode rod BT, and the cylindrical partition wall WL are provided in the middle region AM when the ink tank TK is viewed in a plan view in the Z1 direction.

In the present embodiment, a case is assumed in which, when the ink tank TK is viewed in a plan view in the Z1 direction, the electrode rod BT is provided to intersect the center line Ey, the electrode rod BK intersects the center line Ey, and the electrode rod BK is provided at a position in the X1 direction when viewed from the electrode rod BT. Specifically, in the present embodiment, a case is assumed in which, when the ink tank TK is viewed in a plan view in the Z1 direction, the electrode rod BK is provided in a region of the middle region AM in the X1 direction from the center line Ex, and the electrode rod BT is provided in a region of the middle region AM in the X2 direction from the center line Ex.

In the present embodiment, it is assumed that the cylindrical partition wall WL is provided to intersect the center line Ex and the center line Ey when the ink tank TK is viewed in a plan view in the Z1 direction. However, the present disclosure is not limited to such an aspect. The cylindrical partition wall WL and the electrode rod BK may be provided in a region of the middle region AM in the X1 direction from the center line Ex.

Further, in the present embodiment, it is assumed that the cylindrical partition wall WL and the side wall TTy2 are coupled by a coupling wall CN. In the present embodiment, it is assumed that the coupling wall CN is provided in the center region AMx when the ink tank TK is viewed in a plan view in the Z1 direction.

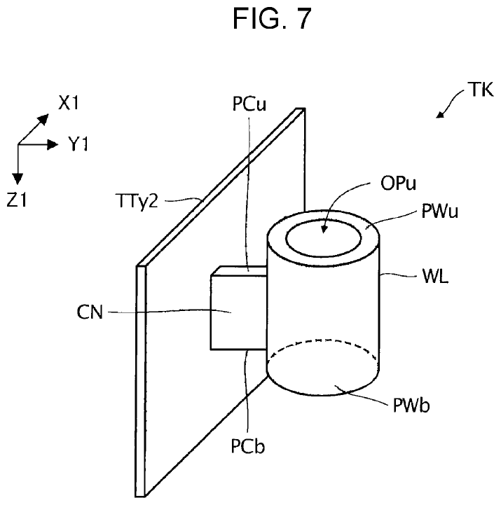

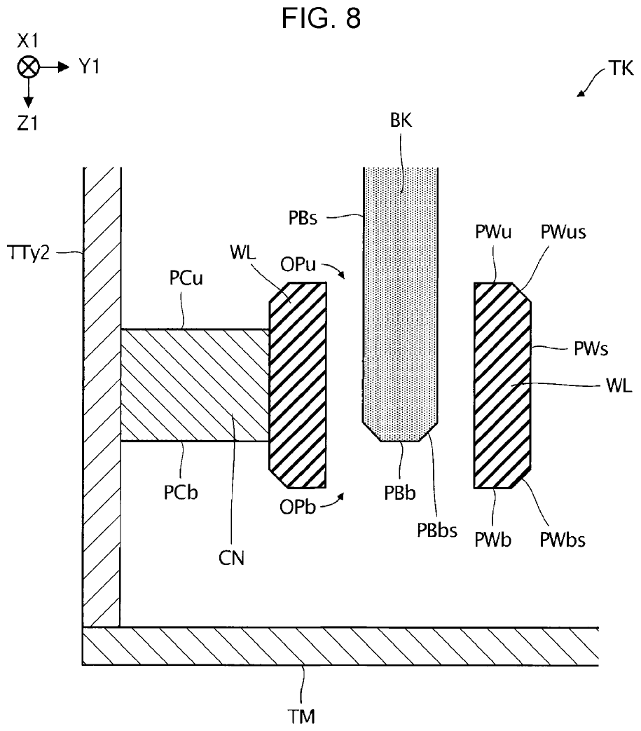

FIG. 7 is a perspective view illustrating an example of a configuration of the ink tank TK. FIG. 8 is a cross-sectional view illustrating the example of the configuration of the ink tank TK.

As illustrated in FIGS. 7 and 8, the ink tank TK includes the cylindrical partition wall WL, the side wall TTy2, and the coupling wall CN as described above.

The coupling wall CN couples the cylindrical partition wall WL and the side wall TTy2. In the present embodiment, a case where the cylindrical partition wall WL, the coupling wall CN, and the side wall TTy2 are integrally formed is assumed. However, the present disclosure is not limited to such an aspect. For example, the cylindrical partition wall WL and the coupling wall CN may be coupled by an adhesive or a screw. In addition, for example, the coupling wall CN and the side wall TTy2 may be coupled by an adhesive or a screw.

The coupling wall CN includes an upper surface PCu which is an end portion of the coupling wall CN in the Z2 direction (upward direction), and a lower surface PCb which is an end portion of the coupling wall CN in the Z1 direction (downward direction).

In the present embodiment, the upper surface PCu of the coupling wall CN is provided between the upper surface PWu and the lower surface PWb of the cylindrical partition wall WL in the Z-axis direction. That is, in the present embodiment, the upper surface PCu of the coupling wall CN is located in the downward direction from the upper surface PWu of the cylindrical partition wall WL.

In the present embodiment, the lower surface PCb of the coupling wall CN is provided between the upper surface PWu and the lower surface PWb of the cylindrical partition wall WL in the Z-axis direction. That is, in the present embodiment, the lower surface PCb of the coupling wall CN is located in the upward direction from the lower surface PWb of the cylindrical partition wall WL.

As illustrated in FIG. 8, the cylindrical partition wall WL includes an outer peripheral surface PWs of which a normal direction is orthogonal to the Z1 direction and which defines an outer periphery of the cylindrical partition wall WL.

In the present embodiment, the outer peripheral surface PWs is an example of an “outer surface of the cylindrical partition wall”.

Further, the cylindrical partition wall WL includes an upper inclined surface PWus and a lower inclined surface PWbs.

The upper inclined surface PWus is a curved surface that couples the upper surface PWu and the outer peripheral surface PWs, and is oriented between the upper surface PWu and the outer peripheral surface PWs. Specifically, the upper inclined surface PWus is a curved surface provided such that when the cylindrical partition wall WL is cut by any plane that is a plane having a normal direction orthogonal to the Z1 direction and passes through a center of the cylindrical partition wall WL when the cylindrical partition wall WL is viewed in the Z1 direction, a normal direction of the upper inclined surface PWus is oriented between a normal direction of the upper surface PWu and a normal direction of the outer peripheral surface PWs at the cut surface.

The lower inclined surface PWbs is a curved surface that couples the lower surface PWb and the outer peripheral surface PWs, and is oriented between the lower surface PWb and the outer peripheral surface PWs. Specifically, the lower inclined surface PWbs is a curved surface provided such that when the cylindrical partition wall WL is cut by any plane that is a plane having a normal direction orthogonal to the Z1 direction and passes through the center of the cylindrical partition wall WL when the cylindrical partition wall WL is viewed in the Z1 direction, a normal direction of the lower inclined surface PWbs is oriented between a normal direction of the lower surface PWb and a normal direction of the outer peripheral surface PWs at the cut surface.

Further, the electrode rod BK includes an electrode side surface PBs, an electrode lower surface PBb, and an electrode inclined surface PBbs.

The electrode side surface PBs is a curved surface of which a normal direction is orthogonal to the Z1 direction, and which defines an outer periphery of the electrode rod BK.

The electrode lower surface PBb is a plane which defines an end portion of the electrode rod BK in the Z1 direction (downward direction), and of which a normal direction is the Z1 direction.

In the present embodiment, the electrode side surface PBs is an example of a “side surface of the first electrode”, and the electrode lower surface PBb is an example of a “lower surface of the first electrode”.

The electrode inclined surface PBbs is a curved surface that couples the electrode lower surface PBb and the electrode side surface PBs and is oriented between the electrode lower surface PBb and the electrode side surface PBs. Specifically, the electrode inclined surface PBbs is a curved surface provided such that when the electrode rod BK is cut by any plane that is a plane having a normal direction orthogonal to the Z1 direction and passes through a center of the electrode rod BK when the electrode rod BK is viewed in the Z1 direction, a normal direction of the electrode inclined surface PBbs is oriented between a normal direction of the electrode lower surface PBb and a normal direction of the electrode side surface PBs at the cut surface.

### 3. Reference Example

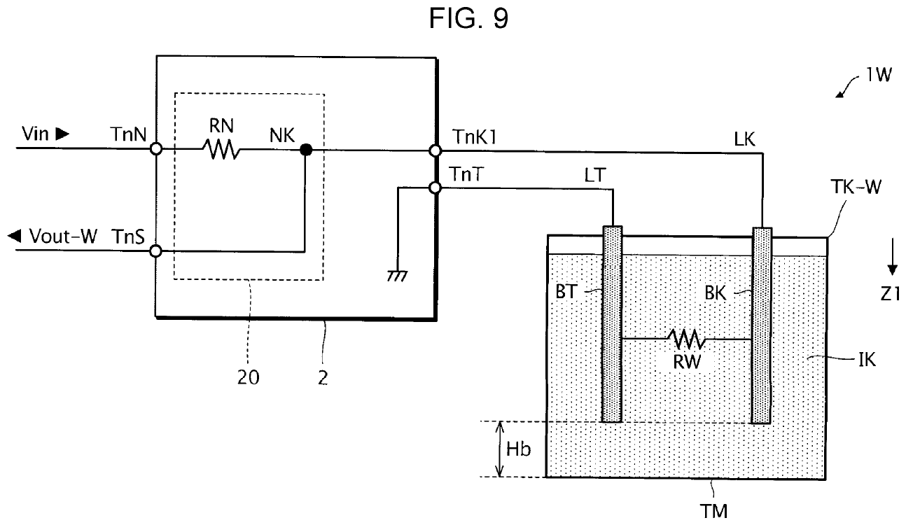

Hereinafter, an overview of an ink jet printer according to Reference Example 1, an overview of an ink jet printer according to Reference Example 2, and an advantage of the ink jet printer 100 according to the present embodiment will be described with reference to FIGS. 9 to 17.

### 3.1. Reference Example 1

Hereinafter, the overview of the ink jet printer according to Reference Example 1 and the advantage of the ink jet printer 100 according to the embodiment as compared with the ink jet printer according to Reference Example 1 will be described with reference to FIGS. 9 to 13. The ink jet printer according to Reference Example 1 is different from the ink jet printer 100 according to the embodiment in that an ink accommodating device 1W is provided instead of the ink accommodating device 1.

FIG. 9 is a circuit diagram describing a configuration of the ink accommodating device 1W.

As illustrated in FIG. 9, the ink accommodating device 1W is different from the ink accommodating device 1 according to the embodiment in that an ink tank TK-W is provided instead of the ink tank TK.

The ink tank TK-W is different from the ink tank TK according to the embodiment in that the ink tank TK-W does not include the cylindrical partition wall WL. That is, in Reference Example 1, the electrode rod BT and the electrode rod BK are accommodated in the ink tank TK-W. In the same manner as the embodiment, in Reference Example 1, the electrode rod BT is provided such that a distance in the Z-axis direction from an end portion of the electrode rod BT in the Z1 direction to the bottom surface TM of the ink tank TK-W is the distance Hb, and the electrode rod BK is provided such that a distance in the Z-axis direction from an end portion of the electrode rod BK in the Z1 direction to the bottom surface TM of the ink tank TK-W is the distance Hb.

In the ink jet printer according to Reference Example 1, when the electrode rod BT and the electrode rod BK are in contact with the inks IK accommodated in the ink tank TK-W, the electrode rod BT and the electrode rod BK are electrically coupled to each other via the inks IK accommodated in the ink tank TK-W. Hereinafter, when the electrode rod BT and the electrode rod BK are electrically coupled to each other via the inks IK accommodated in the ink tank TK-W, an electric resistance of the ink IK that electrically couples the electrode rod BT and the electrode rod BK is referred to as an ink resistance RW. Further, in the following, the output signal Vout output by the ink amount detection circuit 2 provided in the ink accommodating device 1W is referred to as an output signal Vout-W.

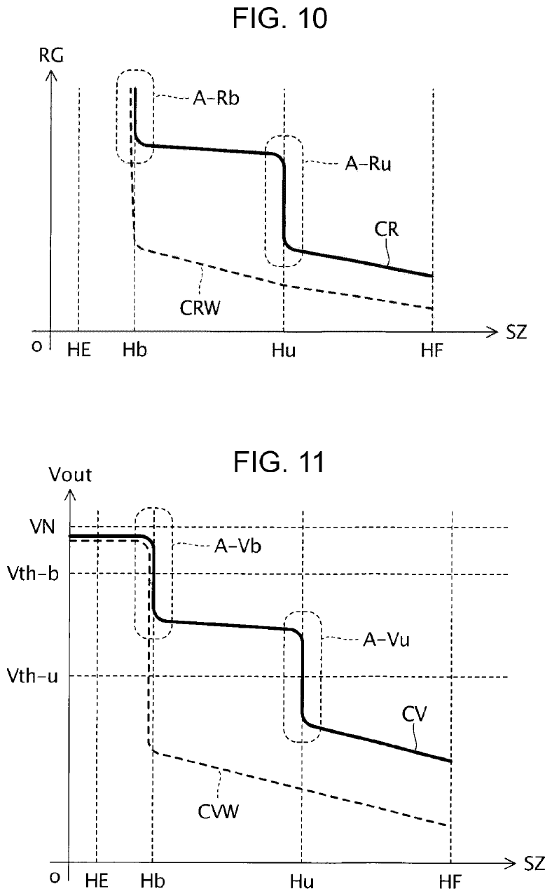

FIG. 10 is an explanatory diagram describing a resistance value change curve CR according to the embodiment and a resistance value change curve CRW according to Reference Example 1. Here, the resistance value change curve CR is a curve indicating a relationship between a resistance value of the ink resistance RG in the embodiment and the ink liquid level distance SZ. In addition, the resistance value change curve CRW is a curve indicating a relationship between a resistance value of the ink resistance RW and the ink liquid level distance SZ in Reference Example 1. In FIG. 10, the relationship between the ink liquid level distance SZ and the resistance value of the ink resistance is represented as the resistance value change curve CR and the resistance value change curve CRW by setting a horizontal axis as the ink liquid level distance SZ and a vertical axis as the resistance value of the ink resistance.

As described above, in the embodiment and Reference Example 1, when the ink liquid level distance SZ is less than the distance Hb, the electrode rod BT and the electrode rod BK are not in contact with the ink IK. That is, when the ink liquid level distance SZ is less than the distance Hb, the electrode rod BT and the electrode rod BK are in a state of not being electrically coupled. On the other hand, when the ink liquid level distance SZ is equal to or greater than the distance Hb, the electrode rod BT and the electrode rod BK are in contact with the ink IK. That is, when the ink liquid level distance SZ is equal to or greater than the distance Hb, the electrode rod BT and the electrode rod BK are in a state of being electrically coupled by the ink IK.

Therefore, as the resistance value change curve CR in FIG. 10 illustrates, in the embodiment, when the ink liquid level distance SZ is equal to or greater than the distance Hb, the ink resistance RG has a smaller resistance value as compared with a case where the ink liquid level distance SZ is smaller than the distance Hb. That is, in the embodiment, the resistance value change curve CR has a change region A-Rb in which the ink resistance RG greatly changes at a boundary between a case where the ink liquid level distance SZ is less than the distance Hb and a case where the ink liquid level distance SZ is equal to or greater than the distance Hb.

In the same manner, as illustrated by the resistance value change curve CRW in FIG. 10, in Reference Example 1, when the ink liquid level distance SZ is equal to or greater than the distance Hb, the ink resistance RW has a small resistance value as compared with a case where the ink liquid level distance SZ is less than the distance Hb. That is, the resistance value change curve CRW according to Reference Example 1 also has the change region A-Rb in which the ink resistance RW changes greatly at the boundary between the case where the ink liquid level distance SZ is less than the distance Hb and the case where the ink liquid level distance SZ is equal to or greater than the distance Hb, in the same manner as the resistance value change curve CR according to the embodiment.

In the embodiment, when the ink liquid level distance SZ is equal to or greater than the distance Hb and equal to or smaller than the distance Hu, an electric resistance of the ink IK that electrically couples the electrode rod BT and the electrode rod BK is maintained at a resistance value substantially the same as a resistance value of the ink resistance RTb. That is, as illustrated in the resistance value change curve CR in FIG. 10, in the embodiment, when the ink liquid level distance SZ is equal to or greater than the distance Hb and equal to or less than the distance Hu, the ink resistance RG is maintained at substantially the same resistance value.

Here, the concept of “substantially the same” includes a case where the same can be regarded as the same when considering an error, in addition to a case where the same is completely the same. Specifically, in the present specification, “substantially the same” is a concept that includes a case where it can be regarded as the same when an error of substantially 10% is considered.

On the other hand, in Reference Example 1, when the ink liquid level distance SZ is equal to or greater than the distance Hb, the ink liquid level distance SZ becomes longer, and the resistance value of the ink resistance RW becomes smaller in accordance with an increase in a cross-sectional area of the ink IK that electrically couples the electrode rod BT and the electrode rod BK. Therefore, as illustrated by the resistance value change curve CRW in FIG. 10, in Reference Example 1, when the ink liquid level distance SZ is equal to or greater than the distance Hb, the resistance value of the ink resistance RW decreases as the ink liquid level distance SZ increases.

In the embodiment, when the ink liquid level distance SZ is longer than the distance Hu, the electrode rod BT and the electrode rod BK are electrically coupled by the ink IK of the ink resistance RTu present in the upper opening OPu, in addition to the ink IK of the ink resistance RTb present in the lower opening OPb. A resistance value of a combined resistance of the ink resistance RTb and the ink resistance RTu when the ink resistance RTb and the ink resistance RTu are coupled in parallel is smaller than a resistance value of the ink resistance RTb alone. Therefore, as illustrated by the resistance value change curve CR in FIG. 10, in the embodiment, when the ink liquid level distance SZ is longer than the distance Hu, the ink resistance RG has a smaller resistance value as compared with a case where the ink liquid level distance SZ is equal to or shorter than the distance Hu. That is, in the embodiment, the resistance value change curve CR has a change region A-Ru in which the ink resistance RG greatly changes at a boundary between a case where the ink liquid level distance SZ is equal to or less than the distance Hu and the case where the ink liquid level distance SZ is longer than the distance Hu.

On the other hand, in Reference Example 1, the cylindrical partition wall WL is not provided in the ink tank TK-W. Therefore, as illustrated in FIG. 10, the resistance value change curve CRW according to Reference Example 1 does not have the change region A-Ru.

In the embodiment, when the ink liquid level distance SZ is longer than the distance Hu, the ink liquid level distance SZ becomes longer, and the resistance value of the ink resistance RG becomes smaller as the cross-sectional area of the ink IK that electrically couples the electrode rod BT and the electrode rod BK becomes larger. Therefore, as illustrated in the resistance value change curve CR in FIG. 10, in the embodiment, when the ink liquid level distance SZ is longer than the distance Hu, the resistance value of the ink resistance RG decreases as the ink liquid level distance SZ becomes longer.

As described above, both the resistance value change curve CR according to the embodiment and the resistance value change curve CRW according to Reference Example 1 have the change region A-Rb.

On the other hand, the resistance value change curve CR according to the embodiment has the change region A-Ru, whereas the resistance value change curve CRW according to Reference Example 1 does not have the change region A-Ru, and has a smooth shape in which the ink resistance RW continuously decreases as the ink liquid level distance SZ becomes longer.

FIG. 11 is an explanatory diagram describing a potential change curve CV according to the embodiment and a potential change curve CVW according to Reference Example 1. Here, the potential change curve CV is a curve indicating a relationship between the output signal Vout output by the ink amount detection circuit 2 in the embodiment and the ink liquid level distance SZ. In addition, the potential change curve CVW is a curve indicating a relationship between the output signal Vout-W output by the ink amount detection circuit 2 and the ink liquid level distance SZ in Reference Example 1. In FIG. 11, the relationship between the ink liquid level distance SZ and a potential of the output signal Vout or the output signal Vout-W is represented by the potential change curve CV and the potential change curve CVW by setting a horizontal axis to the ink liquid level distance SZ and a vertical axis to the potential of the output signal Vout or the output signal Vout-W.

As described above, the potential of the output signal Vout, that is, a potential of the node NK is determined based on a resistance value of the ink resistance RG. Specifically, when the resistance value of the ink resistance RG is large, the potential of the output signal Vout is also high, as compared with a case where the resistance value is small.

As described above, the resistance value change curve CR has the change region A-Rb. Therefore, the potential change curve CV also has a change region A-Vb, which is a region in which the potential of the output signal Vout changes greatly, at a boundary between a case where the ink liquid level distance SZ is less than the distance Hb and a case where the ink liquid level distance SZ is equal to or greater than the distance Hb, as illustrated in FIG. 11.

Further, as described above, the resistance value change curve CRW also has the change region A-Rb. Therefore, the potential change curve CVW also has the change region A-Vb, which is a region in which the potential of the output signal Vout-W changes greatly, at the boundary between the case where the ink liquid level distance SZ is less than the distance Hb and the case where the ink liquid level distance SZ is equal to or greater than the distance Hb, as illustrated in FIG. 11.

In addition, as described above, the resistance value change curve CR has the change region A-Ru. Therefore, the potential change curve CV also has a change region A-Vu, which is a region in which the potential of the output signal Vout changes greatly, at a boundary between a case where the ink liquid level distance SZ is equal to or less than the distance Hu and a case where the ink liquid level distance SZ is longer than the distance Hu, as illustrated in FIG. 11.

As described above, the resistance value change curve CRW does not have the change region A-Ru. Therefore, the potential change curve CVW also does not have the change region A-Vu as illustrated in FIG. 11.

Hereinafter, the potential indicated by the output signal Vout according to the embodiment will be referred to as a threshold potential Vth-b when a temperature of the ink IK in the ink tank TK is a reference temperature t1 and the ink liquid level distance SZ in the ink tank TK is the distance Hb. As illustrated in FIG. 11, when the temperature of the ink IK in the ink tank TK-W is the reference temperature t1 and the ink liquid level distance SZ in the ink tank TK-W is the distance Hb, the potential indicated by the output signal Vout-W in Reference Example 1 is also the threshold potential Vth-b.

In addition, in the following, the potential indicated by the output signal Vout in the embodiment is referred to as a threshold potential Vth-u when the temperature of the ink IK in the ink tank TK is the reference temperature t1 and the ink liquid level distance SZ in the ink tank TK is the distance Hu. As illustrated in FIG. 11, when the temperature of the ink IK in the ink tank TK-W is the reference temperature t1 and the ink liquid level distance SZ in the ink tank TK-W is the distance Hu, the potential indicated by the output signal Vout-W represented by the potential change curve CVW in Reference Example 1 is a potential lower than the threshold potential Vth-u.

Here, the reference temperature t1 is, for example, the temperature of the ink IK in the ink tank TK when the ink jet printer 100 is used in a standard use environment of the ink jet printer 100. Further, the reference temperature t1 may be, for example, an atmospheric temperature of the ink jet printer 100 when the ink jet printer 100 is used in the standard use environment of the ink jet printer 100. Further, the reference temperature t1 may be, for example, a temperature of the standard use environment of the ink IK.

As described above, in the embodiment, the control device 8 specifies the amount of remaining ink IK accommodated in the ink tank TK based on the output signal Vout.

Specifically, in the embodiment, the control device 8 specifies that the amount of remaining ink IK in the ink tank TK is less than the ink amount corresponding to the distance Hb when the potential of the output signal Vout is higher than the threshold potential Vth-b, and specifies that the amount of remaining ink IK in the ink tank TK is an amount larger than the ink amount corresponding to the distance Hb when the potential of the output signal Vout is lower than the threshold potential Vth-b.

Here, the ink amount corresponding to the distance Hb may be an ink amount corresponding to a state in which the amount of ink IK in the ink tank TK is small and is referred to as a so-called “ink end”. In the embodiment, the ink amount corresponding to the distance Hb is an example of a “first liquid amount”.

In the embodiment, the control device 8 specifies that the amount of remaining ink IK in the ink tank TK is less than an ink amount corresponding to the distance Hu when the potential of the output signal Vout is higher than the threshold potential Vth-u, and specifies that the amount of remaining ink IK in the ink tank TK is an amount larger than the ink amount corresponding to the distance Hu when the potential of the output signal Vout is lower than the threshold potential Vth-u.

Here, the ink amount corresponding to the distance Hu may be an ink amount corresponding to a state in which the amount of ink IK in the ink tank TK is large and is referred to as a so-called “full”. In the embodiment, the ink amount corresponding to the distance Hu is an example of a “second liquid amount”.

In addition, in the same manner as the embodiment, in Reference Example 1, the control device 8 specifies that the amount of remaining ink IK in the ink tank TK-W is less than the ink amount corresponding to the distance Hb when the potential of the output signal Vout-W is higher than the threshold potential Vth-b, and specifies that the amount of remaining ink IK in the ink tank TK-W is an amount larger than the ink amount corresponding to the distance Hb when the potential of the output signal Vout-W is lower than the threshold potential Vth-b.

On the other hand, in Reference Example 1, unlike the embodiment, the control device 8 cannot specify whether the amount of remaining ink IK in the ink tank TK-W is less than the ink amount corresponding to the distance Hu based on the determination result of whether the potential of the output signal Vout-W is higher than the threshold potential Vth-u.

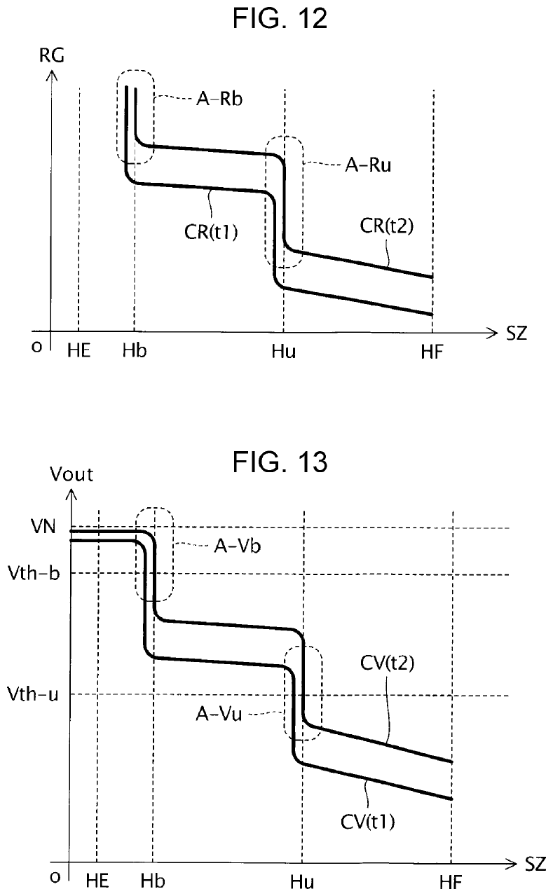

FIG. 12 is an explanatory diagram describing a change in temperature of the resistance value change curve CR by a change in temperature of the ink IK in the ink tank TK according to the embodiment.

Specifically, in FIG. 12, the resistance value change curve CR when the temperature of the ink IK in the ink tank TK is the reference temperature t1 is represented by a resistance value change curve CR(t1), and the resistance value change curve CR when the temperature of the ink IK in the ink tank TK is a temperature t2 different from the reference temperature t1 is represented by a resistance value change curve CR(t2).

As illustrated in FIG. 12, when the temperature of the ink IK in the ink tank TK changes, a resistance value indicated by the resistance value change curve CR also changes. Specifically, when the temperature of the ink IK in the ink tank TK changes from the reference temperature t1 to the temperature t2, a resistance value of the ink resistance RG indicated by the resistance value change curve CR also changes. That is, even when the ink liquid level distance SZ has the same value, the resistance value of the ink resistance RG indicated by the resistance value change curve CR(t1) and the resistance value of the ink resistance RG indicated by the resistance value change curve CR(t2) are different.

As described above, the resistance value change curve CR according to the embodiment has the change region A-Rb in a portion at which the ink liquid level distance SZ is the distance Hb. That is, in the change region A-Rb including the portion at which the ink liquid level distance SZ is the distance Hb in the resistance value change curve CR, the resistance value of the ink resistance RG indicated by the resistance value change curve CR changes greatly. Therefore, in a vertical axis direction of the graph illustrated in FIG. 12, a part of the change region A-Rb of the resistance value change curve CR(t1) and a part of the change region A-Rb of the resistance value change curve CR(t2) overlap each other.

In addition, as described above, the resistance value change curve CR according to the embodiment has the change region A-Ru in a portion at which the ink liquid level distance SZ is the distance Hu. That is, in the change region A-Ru including the portion at which the ink liquid level distance SZ is the distance Hu in the resistance value change curve CR, the resistance value of the ink resistance RG indicated by the resistance value change curve CR changes greatly. Therefore, in the vertical axis direction of the graph illustrated in FIG. 12, a part of the change region A-Ru of the resistance value change curve CR(t1) and a part of the change region A-Ru of the resistance value change curve CR(t2) overlap each other.

FIG. 13 is an explanatory diagram describing a change in temperature of the potential change curve CV by a change in temperature of the ink IK in the ink tank TK according to the embodiment.

Specifically, in FIG. 13, the potential change curve CV when the temperature of the ink IK in the ink tank TK is the reference temperature t1 is represented as a potential change curve CV(t1), and the potential change curve CV when the temperature of the ink IK in the ink tank TK is the temperature t2 is represented as a potential change curve CV(t2).

As illustrated in FIG. 13, when the temperature of the ink IK in the ink tank TK changes, the potential indicated by the potential change curve CV also changes. Specifically, when the temperature of the ink IK in the ink tank TK changes from the reference temperature t1 to the temperature t2, the potential of the output signal Vout indicated by the potential change curve CV also changes. That is, even when the ink liquid level distance SZ has the same value, the potential indicated by the output signal Vout indicated by the potential change curve CV(t1) and the potential indicated by the output signal Vout indicated by the potential change curve CV(t2) are different from each other.

As described above, the potential change curve CV according to the embodiment has the change region A-Vb, which is a region in which the potential of the output signal Vout indicated by the potential change curve CV changes greatly, in a portion at which the ink liquid level distance SZ is the distance Hb. The change region A-Vb of the potential change curve CV(t1) intersects a straight line “Vout=Vth−b” in the graph illustrated in FIG. 13.

In addition, since the change region A-Vb is a region in which the potential of the output signal Vout indicated by the potential change curve CV changes greatly, in a vertical axis direction of the graph illustrated in FIG. 13, a part of the change region A-Vb of the potential change curve CV(t1) and a part of the change region A-Vb of the potential change curve CV(t2) overlap each other. When a temperature difference between the reference temperature t1 and the temperature t2 is within a predetermined temperature difference, the change region A-Vb of the potential change curve CV(t2) intersects the straight line “Vout=Vth−b” in the graph illustrated in FIG. 13.

Here, the predetermined temperature difference may be, for example, a temperature difference between the temperature of the ink IK in the ink tank TK and the reference temperature t1 when the ink jet printer 100 is used in the limited use environment of the ink jet printer 100. Further, the predetermined temperature difference may be, for example, a temperature difference between the atmospheric temperature of the ink jet printer 100 and the reference temperature t1 when the ink jet printer 100 is used in the limited use environment of the ink jet printer 100. Further, the predetermined temperature difference may be, for example, a temperature difference between the temperature of the limited use environment of the ink IK and the reference temperature t1.

As described above, the potential change curve CV according to the embodiment has the change region A-Vu, which is a region at which the potential of the output signal Vout indicated by the potential change curve CV changes greatly, in the portion at which the ink liquid level distance SZ is the distance Hu. The change region A-Vu of the potential change curve CV(t1) intersects a straight line “Vout=Vth−u” in the graph illustrated in FIG. 13.

In addition, since the change region A-Vu is a region in which the potential of the output signal Vout indicated by the potential change curve CV changes greatly, a part of the change region A-Vu of the potential change curve CV(t1) and a part of the change region A-Vu of the potential change curve CV(t2) overlap each other in the vertical axis direction of the graph illustrated in FIG. 13. When a temperature difference between the reference temperature t1 and the temperature t2 is within a predetermined temperature difference, the change region A-Vu of the potential change curve CV(t2) intersects the straight line “Vout=Vth−u” in the graph illustrated in FIG. 13.

Therefore, according to the embodiment, when the temperature of the ink IK in the ink tank TK is the reference temperature t1 or the temperature t2, it can be specified that the amount of remaining ink IK in the ink tank TK is less than an ink amount corresponding to the distance Hb based on the fact that the potential of the output signal Vout is higher than the threshold potential Vth−b, and it can be specified that the amount of remaining ink IK in the ink tank TK is less than an ink amount corresponding to the distance Hu based on the fact that the potential of the output signal Vout is higher than the threshold potential Vth−u.

On the other hand, in the same manner as the embodiment, according to Reference Example 1, when the temperature of the ink IK in the ink tank TK-W is the reference temperature t1 or the temperature t2, it can be specified that the amount of remaining ink IK in the ink tank TK is less than the ink amount corresponding to the distance Hb based on the fact that the potential of the output signal Vout-W is higher than the threshold potential Vth−b. Meanwhile, according to Reference Example 1, unlike the embodiment, when the temperature of the ink IK in the ink tank TK-W is the reference temperature t1 or the temperature t2, the amount of remaining ink IK in the ink tank TK cannot be specified based on the fact that the potential of the output signal Vout-W is higher than the threshold potential Vth−u. That is, according to the ink jet printer 100 according to the embodiment, the amount of remaining ink IK in the ink tank TK can be accurately detected based on the output signal Vout, as compared with the ink jet printer according to Reference Example 1.

In the embodiment, a case where the resistance value of the ink resistance RG changes by the temperature change of the ink IK in the ink tank TK and as a result, the potential of the output signal Vout indicated by the potential change curve CV changes is described as an example, but the present disclosure is not limited to such an aspect. The embodiment can be applied to any case where the potential of the output signal Vout indicated by the potential change curve CV changes.

For example, according to the embodiment, even when the potential of the output signal Vout indicated by the potential change curve CV changes by a deterioration or a change of the ink IK in the ink tank TK, the amount of remaining ink IK in the ink tank TK can be accurately detected based on the output signal Vout as compared with Reference Example 1. In addition, according to the embodiment, even when the potential of the output signal Vout indicated by the potential change curve CV changes by the superposition of a noise on the output signal Vout, the amount of remaining ink IK in the ink tank TK can be accurately detected based on the output signal Vout as compared with Reference Example 1.

### 3.2. Reference Example 2

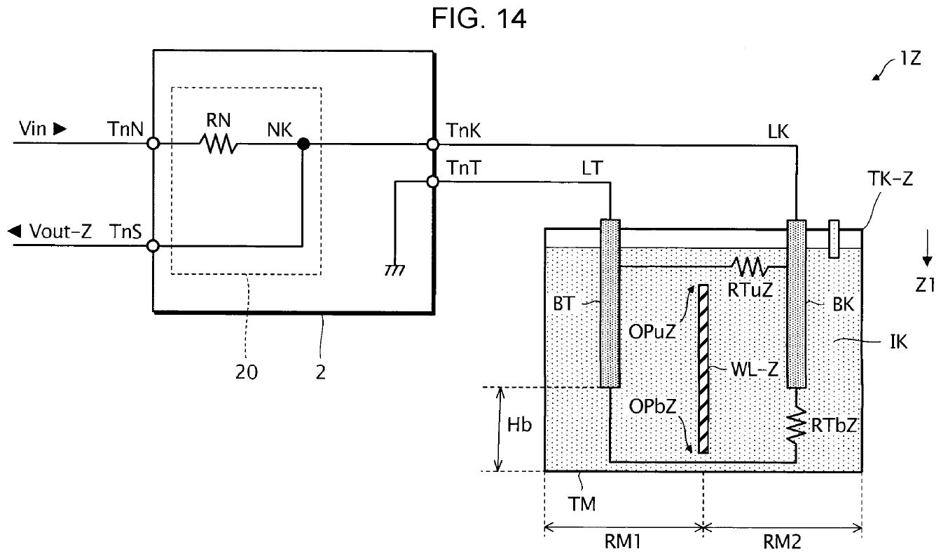

Hereinafter, an overview of the ink jet printer according to Reference Example 2 and the advantage of the ink jet printer 100 according to the embodiment as compared with the ink jet printer according to Reference Example 2 will be described with reference to FIGS. 14 to 17. The ink jet printer according to Reference Example 2 is different from the ink jet printer 100 according to the embodiment in that an ink accommodating device 1Z is provided instead of the ink accommodating device 1.

FIG. 14 is a circuit diagram describing a configuration of the ink accommodating device 1Z.

As illustrated in FIG. 14, the ink accommodating device 1Z is different from the ink accommodating device 1 according to the embodiment in that an ink tank TK-Z is provided instead of the ink tank TK.

The ink tank TK-Z is different from the ink tank TK according to the embodiment in that a flat plate partition wall WL-Z is provided instead of the cylindrical partition wall WL.

The ink tank TK-Z accommodates the electrode rod BT, the electrode rod BK, and the flat plate partition wall WL-Z. The flat plate partition wall WL-Z divides an internal space for the ink tank TK-Z to accommodate the ink IK into an ink chamber RM1 and an ink chamber RM2. The electrode rod BT is accommodated in the ink chamber RM1. The electrode rod BK is accommodated in the ink chamber RM2. In the Z1 direction of the flat plate partition wall WL-Z, a lower opening OPbZ for communicating with the ink chamber RM1 and the ink chamber RM2 is formed. An upper opening OPuZ for communicating with the ink chamber RM1 and the ink chamber RM2 is formed in the Z2 direction of the flat plate partition wall WL-Z.

In the same manner as the embodiment, in Reference Example 2, the electrode rod BT is provided such that a distance in the Z-axis direction from an end portion of the electrode rod BT in the Z1 direction to the bottom surface TM of the ink tank TK-Z is the distance Hb, and the electrode rod BK is provided such that a distance in the Z-axis direction from an end portion of the electrode rod BK in the Z1 direction to the bottom surface TM of the ink tank TK-Z is the distance Hb. Further, in the same manner as the embodiment, in Reference Example 2, it is assumed that the outer periphery of the ink tank TK-Z is defined by the side wall TTx1, the side wall TTx2, the side wall TTy1, and the side wall TTy2.

In Reference Example 2, when the electrode rod BT and the electrode rod BK are electrically coupled to each other via the ink IK that is present in the lower opening OPbZ of the ink tank TK-Z among the inks IK accommodated in the ink tank TK-Z, an electric resistance of the ink IK that electrically couples the electrode rod BT and the electrode rod BK via the lower opening OPbZ is referred to as an ink resistance RTbZ. In addition, in the following, when the electrode rod BT and the electrode rod BK are electrically coupled to each other via the ink IK that is present in the upper opening OPuZ among the inks IK accommodated in the ink tank TK-Z, an electric resistance of the ink IK that electrically couples the electrode rod BT and the electrode rod BK via the upper opening OPuZ is referred to as an ink resistance RTuZ. In addition, in the following, a combined resistance of the ink resistance RTbZ and the ink resistance RTuZ is referred to as an ink resistance RZ. Further, in the following, the output signal Vout output by the ink amount detection circuit 2 according to Reference Example 2 is referred to as an output signal Vout-Z. The output signal Vout-Z indicates a potential determined based on a resistance value of the ink resistance RZ.

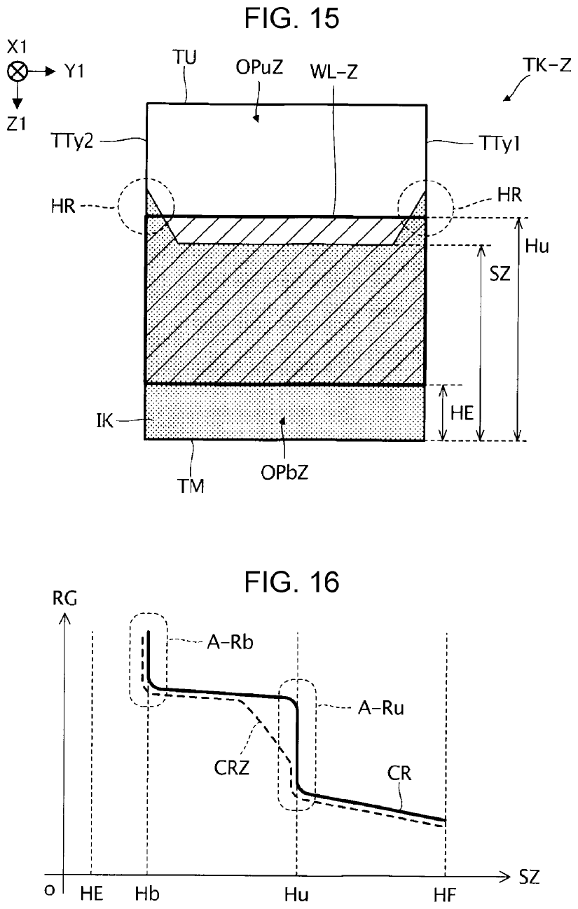

FIG. 15 is a cross-sectional view describing a configuration of the flat plate partition wall WL-Z provided in the ink accommodating device 1Z.

As illustrated in FIG. 15, the flat plate partition wall WL-Z is provided to extend on a plane in which the X1 direction is a normal direction. As described above, the lower opening OPbZ for communicating the ink chamber RM1 and the ink chamber RM2 is provided in the Z1 direction of the flat plate partition wall WL-Z, and the upper opening OPuZ for communicating the ink chamber RM1 and the ink chamber RM2 is provided in the Z2 direction of the flat plate partition wall WL-Z. In Reference Example 2, the flat plate partition wall WL-Z is provided such that a distance from the bottom surface TM of the ink tank TK-Z to a lower end of the flat plate partition wall WL-Z is the distance HE, and the distance from the bottom surface TM of the ink tank TK-Z to the upper end of the flat plate partition wall WL-Z is the distance Hu.

As illustrated in FIG. 15, in the present embodiment, the flat plate partition wall WL-Z forms a non-continuous portion HR between the side wall TTy1 and the side wall TTy2. Here, the non-continuous portion HR is a portion that does not correspond to either a smooth shape or a continuous shape, and has a non-continuous shape or an irregular shape, and thus, a locally narrow location is formed. In the example illustrated in FIG. 15, since the flat plate partition wall WL-Z and the side wall TTy1 intersect at a right angle, a shape of the intersecting portion is non-continuous, and a narrow location is formed in the vicinity of the intersection of the flat plate partition wall WL-Z and the side wall TTy1. In the same manner, since the flat plate partition wall WL-Z and the side wall TTy2 intersect at a right angle, a shape of the intersecting portion is non-continuous, and a narrow location is formed in the vicinity of the intersection of the flat plate partition wall WL-Z and the side wall TTy2. In the non-continuous portion HR, the ink IK permeates into the narrow location of the non-continuous portion HR, and the ink crawls up the narrow location, so-called capillary phenomenon occurs. As a result, when the non-continuous portion HR is present, the ink IK overcomes the flat plate partition wall WL-Z even though the ink liquid level distance SZ is less than the distance Hu. That is, when the non-continuous portion HR is present, the electrode rod BT and the electrode rod BK are electrically coupled to each other via the ink IK that is present at the upper opening OPuZ of the ink tank TK-Z among the inks IK accommodated in the ink tank TK-Z, even though the ink liquid level distance SZ is less than the distance Hu.

FIG. 16 is an explanatory diagram describing the resistance value change curve CR according to the embodiment and a resistance value change curve CRZ according to Reference Example 2. Here, the resistance value change curve CRZ is a curve indicating a relationship between a resistance value of the ink resistance RZ and the ink liquid level distance SZ in Reference Example 2.

As described above, in Reference Example 2, when the ink liquid level distance SZ is less than the distance Hb, the electrode rod BT and the electrode rod BK are not in contact with the ink IK. In addition, in Reference Example 2, when the ink liquid level distance SZ is equal to or greater than the distance Hb, the electrode rod BT and the electrode rod BK are in contact with the ink IK. Therefore, the resistance value change curve CRZ has the change region A-Rb in which the ink resistance RZ changes greatly at a boundary between a case where the ink liquid level distance SZ is less than the distance Hb and a case where the ink liquid level distance SZ is equal to or greater than the distance Hb, in the same manner as the resistance value change curve CR according to the embodiment.

On the other hand, in Reference Example 2, when the ink liquid level distance SZ is equal to or less than the distance Hu, as a difference between the ink liquid level distance SZ and the distance Hu becomes smaller, the ink IK overcomes the non-continuous portion HR, and the electrode rod BT and the electrode rod BK are electrically coupled via the ink IK that is present in the upper opening OPuZ of the ink tank TK-Z among the inks IK accommodated in the ink tank TK-Z. Therefore, in Reference Example 2, when the ink liquid level distance SZ is equal to or less than the distance Hu, the ink resistance RZ is maintained at a resistance value substantially the same as the resistance value of the ink resistance RTbZ when the difference between the ink liquid level distance SZ and the distance Hu is sufficiently large. Meanwhile, when the difference between the ink liquid level distance SZ and the distance Hu is small, the ink resistance RZ changes to a resistance value smaller than the resistance value of the ink resistance RTbZ as the difference becomes smaller.

As a result, the resistance value change curve CRZ according to Reference Example 2 has a smaller change amount of the ink resistance RZ at a boundary between a case where the ink liquid level distance SZ is equal to or less than the distance Hu and a case where the ink liquid level distance SZ is longer than the distance Hu, as compared with the resistance value change curve CR according to the embodiment. That is, in the resistance value change curve CRZ according to Reference Example 2, the change amount of the ink resistance RZ in the change region A-Ru is smaller than that in the resistance value change curve CR according to the embodiment.

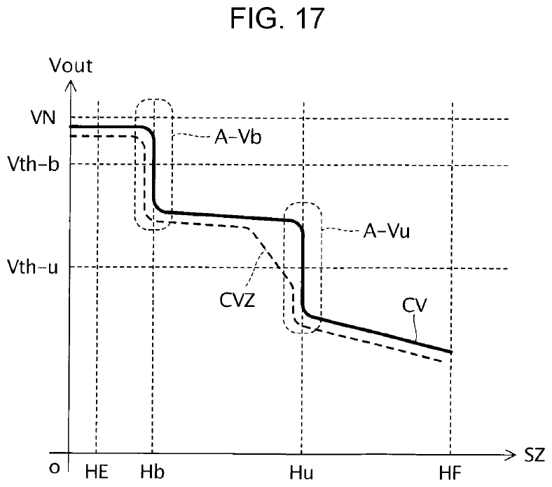

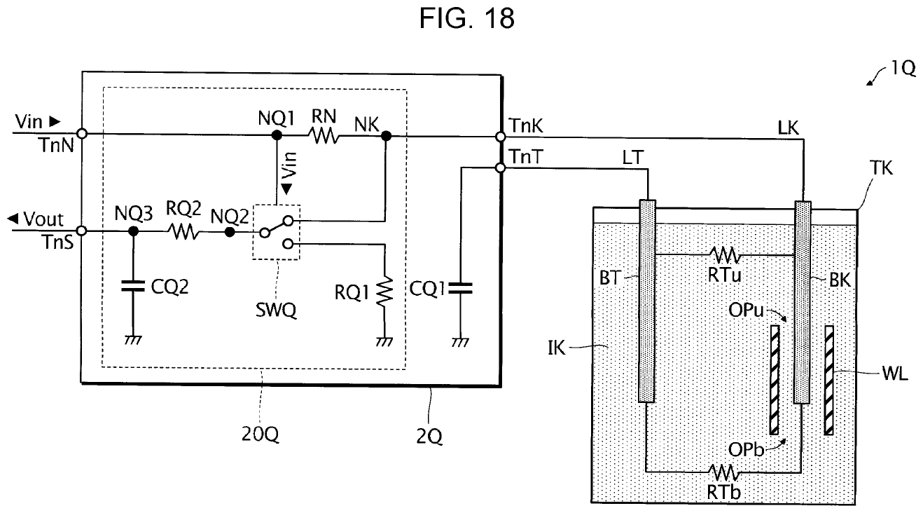

FIG. 17 is an explanatory diagram describing the potential change curve CV according to the embodiment and the potential change curve CVZ according to Reference Example 2. Here, the potential change curve CVZ is a curve indicating a relationship between the output signal Vout-Z output by the ink amount detection circuit 2 and the ink liquid level distance SZ in Reference Example 2. In FIG. 17, by setting a horizontal axis to the ink liquid level distance SZ and a vertical axis to the potential of the output signal Vout or the output signal Vout-Z, the relationship between the ink liquid level distance SZ and the potential of the output signal Vout or the output signal Vout-Z is represented as the potential change curve CV and the potential change curve CVZ.

As described above, the resistance value change curve CRZ has the change region A-Ru. Therefore, the potential change curve CVZ also has the change region A-Vu, which is a region at which the potential of the output signal Vout changes, at the boundary between the case where the ink liquid level distance SZ is equal to or less than the distance Hu and the case where the ink liquid level distance SZ is longer than the distance Hu, as illustrated in FIG. 17. Meanwhile, as described above, the change amount of the ink resistance RZ in the change region A-Ru of the resistance value change curve CRZ is smaller than the change amount of the ink resistance RG in the change region A-Ru of the resistance value change curve CR. Therefore, the change amount of the potential output signal Vout-Z in the change region A-Vu of the potential change curve CVZ is smaller than the change amount of the potential output signal Vout in the change region A-Vu of the potential change curve CV. Therefore, when a temperature of the ink IK in the ink tank TK-Z is the reference temperature t1 and the ink liquid level distance SZ in the ink tank TK-Z is the distance Hu, a potential indicated by the output signal Vout-Z represented by the potential change curve CVZ in Reference Example 2 is lower than the threshold potential Vth−u. Therefore, in Reference Example 2, unlike the embodiment, when the control device 8 specifies whether the amount of remaining ink IK in the ink tank TK-Z is less than an ink amount corresponding to the distance Hu based on a determination result of whether the potential of the output signal Vout-Z is higher than the threshold potential Vth−u, there is a high possibility that the specifying result becomes inaccurate.

### 4. Conclusion of Embodiment

As described above, in the present embodiment, the ink tank TK is provided with the electrode rod BK, the electrode rod BT, and the cylindrical partition wall WL that covers the electrode rod BK. Therefore, according to the present embodiment, whether the amount of remaining ink IK in the ink tank TK is less than the ink amount corresponding to the distance Hu can be specified. Therefore, according to the present embodiment, the amount of remaining ink IK in the ink tank TK can be more accurately grasped, as compared with the aspect in which the cylindrical partition wall WL is not provided in the ink tank TK as in Reference Example 1.

In the present embodiment, the cylindrical partition wall WL has a cylindrical shape. Therefore, in the present embodiment, the cylindrical partition wall WL has a smooth and continuous shape, and does not have the non-continuous portion HR. Therefore, according to the present embodiment, whether the ink amount is less than the distance Hu can be more accurately specified, as compared with Reference Example 2 in which the flat plate partition wall WL-Z has the non-continuous portion HR. Therefore, according to the present embodiment, the amount of remaining ink IK in the ink tank TK can be more accurately grasped, as compared with the aspect in which the flat plate partition wall WL-Z includes the non-continuous portion HR as in Reference Example 2.

In the present embodiment, the cylindrical partition wall WL has a cylindrical shape. Therefore, in the present embodiment, as compared with the aspect in which the flat plate partition wall WL-Z having a flat plate shape is adopted as in Reference Example 2, a length of an outer periphery of the cylindrical partition wall WL in the Z1 direction in a plan view can be reduced. Therefore, according to the present embodiment, as compared with Reference Example 2, the possibility that the non-continuous portion HR occurs in the cylindrical partition wall WL is reduced, and the amount of remaining ink IK in the ink tank TK can be more accurately grasped.

In the present embodiment, the electrode rod BT and the electrode rod BK are provided in the middle region AM. Therefore, according to the present embodiment, the amount of remaining ink IK in the ink tank TK can be accurately grasped even when the ink jet printer 100 is inclined, as compared with the aspect in which the electrode rod BT and the electrode rod BK are provided in the regions different from the middle region AM.

In the present embodiment, the upper surface PCu of the coupling wall CN is provided in a downward direction from the upper surface PWu of the cylindrical partition wall WL. Therefore, according to the present embodiment, the possibility that the non-continuous portion HR is generated in the cylindrical partition wall WL can be reduced and the amount of remaining ink IK in the ink tank TK can be more accurately grasped, as compared with the aspect in which the upper surface PCu of the coupling wall CN is provided at the same position as the upper surface PWu of the cylindrical partition wall WL in the Z-axis direction and the aspect in which the upper surface PCu of the coupling wall CN is provided in the upward direction from the upper surface PWu of the cylindrical partition wall WL.

In the present embodiment, the lower surface PWb of the cylindrical partition wall WL is provided in the downward direction from the electrode lower surface PBb of the electrode rod BK. Therefore, according to the present embodiment, the resistance value of the ink resistance RTb can be set to a large value, as compared with the aspect in which the lower surface PWb of the cylindrical partition wall WL is provided in the upward direction from the electrode lower surface PBb of the electrode rod BK. Therefore, according to the present embodiment, the change amount of the ink resistance RG in the change region A-Ru can be increased and the amount of remaining ink IK in the ink tank TK can be more accurately grasped, as compared with the aspect in which the lower surface PWb of the cylindrical partition wall WL is provided in the upward direction from the electrode lower surface PBb of the electrode rod BK.

In the present embodiment, the electrode rod BK has the electrode inclined surface PBbs. Therefore, according to the present embodiment, as compared with an aspect in which the electrode rod BK does not have the electrode inclined surface PBbs, the possibility that the state in which the ink IK and the electrode rod BK are in contact with each other is maintained when the ink liquid level distance SZ is less than the distance Hb can be reduced. Therefore, according to the present embodiment, the amount of remaining ink IK in the ink tank TK can be more accurately grasped, as compared with the aspect in which the electrode rod BK does not have the electrode inclined surface PBbs.

### B. Modification Example

Each form exemplified above can be variously modified. A specific aspect of the modification is illustrated below. Any two or more aspects selected from the following examples can be combined as appropriate as long as there is no contradiction.

### Modification Example 1

In the present embodiment, a case where the ink accommodating device 1 includes the output circuit 20 is described as an example, but the present disclosure is not limited to such an aspect. The ink accommodating device 1 may include an output circuit configured to detect the amount of remaining ink IK accommodated in the ink tank TK, based on an electric signal from one or a plurality of electrode rods provided in the ink tank TK.

FIG. 18 is a circuit diagram illustrating an example of a configuration of an ink accommodating device 1Q included in an ink jet printer according to Modification Example 1. The ink jet printer according to Modification Example 1 differs from the ink jet printer 100 according to the embodiment in that the ink accommodating device 1Q is provided instead of the ink accommodating device 1. Further, the ink accommodating device 1Q is different from the ink accommodating device 1 according to the embodiment in that the ink accommodating device 1Q includes an ink amount detection circuit 2Q instead of the ink amount detection circuit 2. That is, the ink accommodating device 1Q includes the ink amount detection circuit 2Q and the ink tank TK.

As illustrated in FIG. 18, the ink amount detection circuit 2Q includes the input terminal TnN, the detection terminal TnK, the reference potential coupling terminal TnT, the output terminal TnS, a capacitance CQ1, and an output circuit 20Q including the node NK.

The input signal Vin is input to the input terminal TnN. The detection terminal TnK is electrically coupled to the electrode rod BK via the detection wiring LK. The reference potential coupling terminal TnT is electrically coupled to the electrode rod BT via the reference potential coupling wiring LT. The output terminal TnS outputs the output signal Vout. In the capacitance CQ1, one electrode, of two electrodes included in the capacitance CQ1, is electrically coupled to the reference potential coupling terminal TnT and the other electrode is electrically coupled to a wiring set to a ground potential.

The output circuit 20Q includes the node NK, a node NQ1, a node NQ2, a node NQ3, the input resistor RN, a resistance RQ1, a resistance RQ2, a capacitance CQ2, and a switch SWQ.

The node NK is electrically coupled to the detection terminal TnK and is electrically coupled to one end of the input resistor RN.

The node NQ1 is electrically coupled to the other end of the input resistor RN and is electrically coupled to the input terminal TnN, and the input signal Vin is supplied via the input terminal TnN.

The switch SWQ includes two input terminals, one output terminal, and one control terminal. One input terminal, of the two input terminals included in the switch SWQ, is electrically coupled to the node NK and the other input terminal is electrically coupled to one end of the resistor RQ1. The output terminal included in the switch SWQ is electrically coupled to the node NQ2. The input signal Vin is supplied to the control terminal included in the switch SWQ via the node NQ1.

In the present modification example, the input signal Vin is a signal set to have a signal level of either a high level or a low level.

In the present modification example, when the input signal Vin supplied to the switch SWQ is at a low level, the switch SWQ electrically couples the output terminal included in the switch SWQ and one input terminal of the two input terminals included in the switch SWQ. That is, in the present modification example, when the input signal Vin supplied to the switch SWQ is at a low level, the switch SWQ electrically couples the node NK and the node NQ2.

Further, in the present modification example, when the input signal Vin supplied to the switch SWQ is at a high level, the switch SWQ electrically couples the output terminal included in the switch SWQ and the other input terminal of the two input terminals included in the switch SWQ. That is, in the present modification example, when the input signal Vin supplied to the switch SWQ is at a high level, the switch SWQ electrically couples one end of the resistor RQ1 and the node NQ2.

One end of the resistor RQ1 is electrically coupled to the other input terminal of the two input terminals included in the switch SWQ, and the other end is electrically coupled to a wiring set to a ground potential.

One end of the resistor RQ2 is electrically coupled to the node NQ2, and the other end is electrically coupled to the node NQ3.

In the capacitance CQ2, one electrode, of two electrodes included in the capacitance CQ2, is electrically coupled to the node NQ3 and the other electrode is electrically coupled to a wiring set to a ground potential. The resistor RQ2 and the capacitance CQ2 function as low pass filters.

The output terminal TnS is electrically coupled to the node NQ3 and outputs the output signal Vout indicating a potential of the node NQ3.

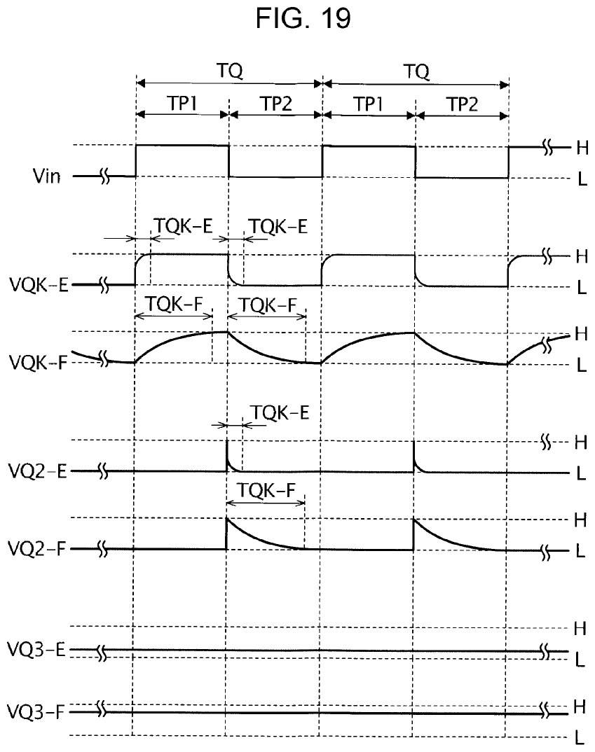

FIG. 19 is a timing chart describing various signals flowing through the ink amount detection circuit 2Q.

As illustrated in FIG. 19, in the present modification example, it is assumed that an operation period of the ink amount detection circuit 2Q is divided into a plurality of unit periods TQ. In the present modification example, it is assumed that each unit period TQ is divided into a control period TP1 and a control period TP2.

The input signal Vin is set to a high level in the control period TP1 in the unit period TQ and is set to a low level in the control period TP2 in the unit period TQ.

A signal VQK is a signal indicating a potential of the node NK. Hereinafter, the signal VQK when the ink IK accommodated in the ink tank TK is less than an ink amount corresponding to the distance Hb, that is, when the ink IK in the ink tank TK is exhausted, is referred to as a signal VQK-E. Further, the signal VQK when the ink IK accommodated in the ink tank TK is larger than the ink amount corresponding to the distance Hu, that is, when the ink IK in the ink tank TK is abundant, is referred to as a signal VQK-F.

When the ink IK in the ink tank TK is exhausted, the electrode rod BT and the electrode rod BK are in a state of not being electrically coupled. Therefore, the signal VQK-E indicates a waveform having a shape linked to the input signal Vin. Specifically, the signal VQK-E rises from a low level to a high level with a delay of a time TQK-E from a time at which the input signal Vin rises from a low level to a high level and falls from a high level to a low level with a delay of the time TQK-E from a time at which the input signal Vin falls from a high level to a low level. Here, the time TQK-E is a time shorter than a time length of the control period TP1 and shorter than a time length of the control period TP2, and is a time for charging a capacitance parasitic to the detection wiring LK, the electrode rod BK, or the like.

When the ink IK in the ink tank TK is abundant, the electrode rod BT and the electrode rod BK are in a state of being electrically coupled to each other. Therefore, the signal VQK-F indicates a waveform in which the input signal Vin is rounded. Specifically, the signal VQK-F rises from a low level to a high level with a delay of a time TQK-F from a time at which the input signal Vin rises from a low level to a high level and falls from a high level to a low level with a delay of the time TQK-F from a time at which the input signal Vin falls from a high level to a low level. Here, the time TQK-F is a time longer than the time TQK-E, and is a time for charging the capacitance CQ1 and a capacitance parasitic on the reference potential coupling wiring LT and the electrode rod BT, in addition to a capacitance parasitic on the detection wiring LK and the electrode rod BK or the like.

A signal VQ2 is a signal indicating a potential of the node NQ2. Hereinafter, the signal VQ2 when the ink IK in the ink tank TK is exhausted and the ink liquid level distance SZ in the ink tank TK is less than the distance Hb is referred to as a signal VQ2-E. Further, the signal VQ2 when the ink IK in the ink tank TK is abundant and the ink liquid level distance SZ in the ink tank TK is longer than the distance Hu is referred to as a signal VQ2-F.

As described above, in the control period TP1 in which the input signal Vin is at a high level, the switch SWQ electrically couples the node NQ2 and one end of the resistor RQ1. Therefore, the signal VQ2 is set to a low level in the control period TP1.

Further, in the control period TP2 in which the input signal Vin is at a low level, the switch SWQ electrically couples the node NQ2 and the node NK. Therefore, in the control period TP2, the signal VQ2-E indicates a waveform having a shape for requiring the time TQK-E to fall from a high level to a low level. Further, in the control period TP2, the signal VQ2-F indicates a waveform having a shape for requiring the time TQK-F to fall from a high level to a low level.

A signal VQ3 is a signal indicating a potential of the node NQ3. Hereinafter, the signal VQ3 when the ink IK in the ink tank TK is exhausted and the ink liquid level distance SZ in the ink tank TK is less than the distance Hb is referred to as a signal VQ3-E. Further, the signal VQ3 when the ink IK in the ink tank TK is abundant and the ink liquid level distance SZ in the ink tank TK is longer than the distance Hu is referred to as a signal VQ3-F.

As described above, the resistor RQ2 and the capacitance CQ2 function as low pass filters. Therefore, the signal VQ3 becomes a signal having a waveform in which the high frequency component is removed from the signal VQ2. As described above, the time TQK-F is longer than the time TQK-E. Therefore, the signal VQ3-F has a higher potential than a potential of the signal VQ3-E. That is, in the present modification example, the ink amount detection circuit 2Q outputs the output signal Vout having a high potential when the ink IK in the ink tank TK is abundant and the ink liquid level distance SZ in the ink tank TK is longer than the distance Hu, as compared with a case where the ink IK in the ink tank TK is exhausted and the ink liquid level distance SZ in the ink tank TK is shorter than the distance Hb.

### Modification Example 2

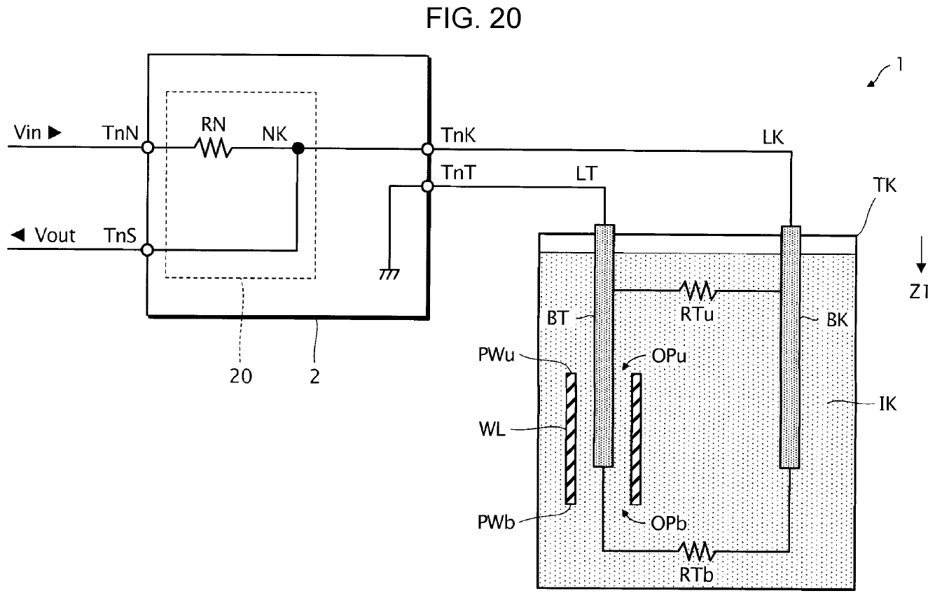

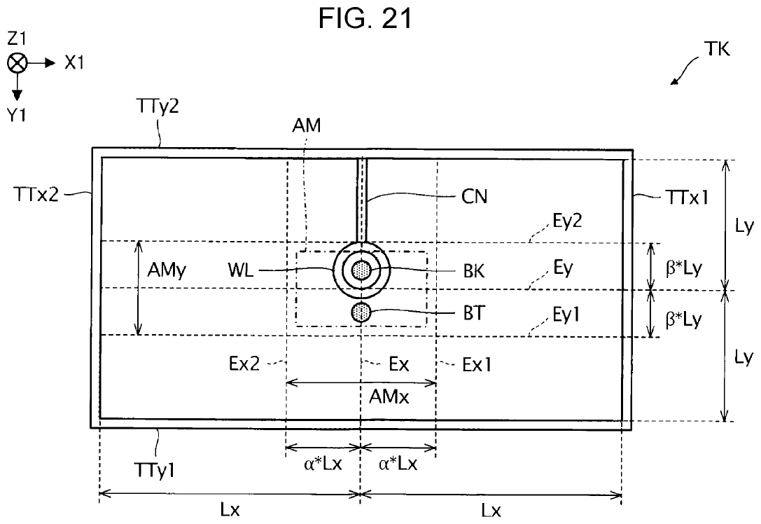

In the above-described embodiment and Modification Example 1, the aspect in which the electrode rod BK is covered with the cylindrical partition wall WL is described as an example, but the present disclosure is not limited to such an aspect. For example, as illustrated in FIG. 20, the electrode rod BT may be covered with the cylindrical partition wall WL.

### Modification Example 3

In the above-described embodiment and Modification Examples 1 and 2, the aspect in which the electrode rod BK and the electrode rod BT are disposed to be aligned in the X-axis direction when the ink tank TK is viewed in a plan view in the Z1 direction is described as an example, but the present disclosure is not limited to such an aspect. The electrode rod BK and the electrode rod BT may be disposed to be aligned in a direction different from the X-axis direction.

FIG. 21 is a plan view illustrating an example of a configuration of the ink tank TK according to the present modification example.

In the present modification example, as illustrated in FIG. 21, when the ink tank TK is viewed in a plan view in the Z1 direction, the electrode rod BK, the electrode rod BT, and the cylindrical partition wall WL are provided in the middle region AM.

In addition, in the present modification example, when the ink tank TK is viewed in a plan view in the Z1 direction, the electrode rod BK and the electrode rod BT are disposed to be aligned in the Y-axis direction. Specifically, when the ink tank TK is viewed in a plan view in the Z1 direction, the electrode rod BK is provided to intersect the center line Ex, the electrode rod BT is provided to intersect the center line Ex, and the electrode rod BT is provided at a position in the Y1 direction when viewed from the electrode rod BK. More specifically, in the present modification example, when the ink tank TK is viewed in a plan view in the Z1 direction, the electrode rod BT is provided in a region of the middle region AM in the Y1 direction from the center line Ey, and the electrode rod BK is provided in a region of the middle region AM in the Y2 direction from the center line Ey.

In addition, in the present modification example, the cylindrical partition wall WL is provided to intersect the center line Ex and the center line Ey when the ink tank TK is viewed in a plan view in the Z1 direction. However, the present disclosure is not limited to such an aspect. The cylindrical partition wall WL and the electrode rod BK may be provided in the region in the Y2 direction from the center line Ey in the middle region AM.

Further, in the present modification example, a case where the cylindrical partition wall WL and the side wall TTy2 are coupled by the coupling wall CN is assumed. In the present modification example, it is assumed that the coupling wall CN is provided in the center region AMx when the ink tank TK is viewed in a plan view in the Z1 direction.

According to the present modification example, the electrode rod BT and the electrode rod BK are disposed along the Y-axis direction, which is a short side direction of the ink tank TK. Therefore, according to the present modification example, the amount of remaining ink IK in the ink tank TK can be accurately grasped even when the ink jet printer 100 is inclined, as compared with the aspect in which the electrode rod BT and the electrode rod BK are disposed along the direction different from the Y-axis direction.

### Modification Example 4

In the above-described embodiment and Modification Examples 1 to 3, a case where the ink accommodating device 1 is provided with the M ink amount detection circuits 2 corresponding to the M ink tanks TK[1] to TK[M] on a one-to-one basis is described as an example, but the present disclosure is not limited to such an aspect. The ink accommodating device 1 may be provided with the number of ink amount detection circuits 2, which is less than M.

For example, the ink accommodating device 1 may be provided with one ink amount detection circuit 2. In this case, for example, the ink amount detection circuit 2 may divide the operation period of the ink amount detection circuit 2 into M unit operation periods and detect the amount of remaining ink IK accommodated in the ink tank TK[m] in the m-th unit operation period. Specifically, the ink amount detection circuit 2 may be configured to switch the ink tank TK[m] coupled to the ink amount detection circuit 2 for each unit operation period.

### Modification Example 5

In the above-described embodiment and Modification Examples 1 to 4, as the ink jet printer 100, a serial type ink jet printer in which the storage case 921 on which the liquid ejecting head 3 is mounted is reciprocated in the main scanning direction MH1 is exemplified, but the present disclosure is not limited to such an aspect. The ink jet printer 100 may be a line-type printing apparatus including the liquid ejecting head 3 configured to eject the ink IK over the entire width of the medium PP.

### Modification Example 6

The liquid ejecting apparatus described by exemplifying the ink jet printer in the above-described embodiment and modification examples 1 to 5 can be adopted in various apparatuses such as a facsimile machine and a copying machine, in addition to an apparatus dedicated to printing. Further, the application of the liquid ejecting apparatus of the present disclosure is not limited to printing. For example, a liquid ejecting apparatus that ejects a solution of a coloring material is used as a manufacturing apparatus that forms a color filter of a liquid crystal display device. Further, the liquid ejecting apparatus that ejects a solution of a conductive material is utilized as a manufacturing apparatus that forms wiring and electrodes of a wiring substrate.

### C. Appendices

The aspects related to the above description are added below. In order to facilitate understanding of each aspect, in the following, reference signs in the drawings are given in parentheses for convenience, but the present disclosure is not limited to the illustrated aspect.

### C. 1. Appendix 1

Hereinafter, the ink jet printer 100 according to Appendix 1 will be described.

### Appendix 1-1

The ink jet printer 100 according to Appendix 1-1 includes the ink tank TK that accommodates the ink IK, the electrode rod BK accommodated in the ink tank TK, the electrode rod BT accommodated in the ink tank TK, the cylindrical partition wall WL that is accommodated in the ink tank TK and is provided to cover at least a part of the electrode rod BK, the ink amount detection circuit 2 that is electrically coupled to the electrode rod BK and the electrode rod BT and outputs the output signal Vout according to an electric signal from one of the electrode rod BK and the electrode rod BT, and the control device 8 that specifies the amount of remaining ink IK accommodated in the ink tank TK based on the output signal Vout, in which the upper surface PWu of the cylindrical partition wall WL is formed with the upper opening OPu through which the electrode rod BK is inserted, the lower surface PWb of the cylindrical partition wall WL is formed with the lower opening OPb, and when the inks IK accommodated in the ink tank TK are present in the upper opening OPu and the lower opening OPb, the electrode rod BK and the electrode rod BT are in contact with the ink IK accommodated in the ink tank TK.

According to Appendix 1-1, an electric resistance value between the electrode rod BK and the electrode rod BT is a different value in three states, that is, a state in which the ink IK accommodated in the ink tank TK is not in contact with the electrode rod BK and the electrode rod BT, a state in which the ink IK accommodated in the ink tank TK is not present above the upper opening OPu and the ink IK is in contact with the electrode rod BK and the electrode rod BT, and a state in which the ink IK accommodated in the ink tank TK is present above the upper opening OPu and the ink IK is in contact with the electrode rod BK and the electrode rod BT. Therefore, the amount of remaining ink IK accommodated in the ink tank TK can be grasped based on the electric resistance value between the electrode rod BK and the electrode rod BT.

Further, according to Appendix 1-1, since the electrode rod BK is covered with the cylindrical partition wall WL having a cylindrical shape, a size of the cylindrical partition wall WL can be reduced, as compared with a case where the electrode rod BK is covered with the flat plate-shaped partition wall. Therefore, according to Appendix 1-1, a situation in which the amount of remaining ink IK cannot be accurately specified since the ink IK overcomes the cylindrical partition wall WL even though a level of the ink IK is lower than the cylindrical partition wall WL can be suppressed.

Further, according to Appendix 1-1, since the electrode rod BK is covered with the cylindrical partition wall WL having a cylindrical shape, occurrence of the non-continuous portion HR in the vicinity of the cylindrical partition wall WL can be suppressed, as compared with a case where the electrode rod BK is covered with the flat plate-shaped partition wall. Therefore, according to Appendix 1-1, a situation in which the amount of remaining ink IK cannot be accurately specified since the ink IK overcomes the cylindrical partition wall WL even though a level of the ink IK is lower than the cylindrical partition wall WL can be suppressed.

### Appendix 1-2

The ink jet printer 100 according to Appendix 1-2 is the ink jet printer 100 according to Appendix 1-1, in which the cylindrical partition wall WL is formed integrally with the side wall TTy2 of the ink tank TK.

According to Appendix 1-2, the number of components of the ink tank TK can be reduced, as compared with an aspect in which the cylindrical partition wall WL and the ink tank TK are separately formed.

Further, according to Appendix 1-2, accuracy of positioning the cylindrical partition wall WL with respect to the ink tank TK can be improved and detection accuracy of the amount of remaining ink IK accommodated in the ink tank TK can be improved, as compared with the aspect in which the cylindrical partition wall WL and the ink tank TK are separately formed.

### Appendix 1-3

The ink jet printer 100 according to Appendix 1-3 is the ink jet printer 100 according to Appendix 1-1 or 1-2, and includes the coupling wall CN that couples the cylindrical partition wall WL and the side wall TTy2 of the ink tank TK.

According to Appendix 1-3, the electrode rod BK covered with the cylindrical partition wall WL can be disposed near the middle region AM of the ink tank TK, as compared with the aspect in which the cylindrical partition wall WL is directly attached to the side wall TTy2. Therefore, according to Appendix 1-3, the amount of remaining ink IK in the ink tank TK can be accurately grasped even when the ink jet printer 100 is inclined.

### Appendix 1-4

The ink jet printer 100 according to Appendix 1-4 is the ink jet printer 100 according to Appendix 1-3, in which the upper surface PCu of the coupling wall CN is disposed between the upper surface PWu of the cylindrical partition wall WL and the lower surface PWb of the cylindrical partition wall WL in the Z-axis direction.

According to Appendix 1-4, the possibility that the non-continuous portion HR is generated in the cylindrical partition wall WL can be reduced and the amount of remaining ink IK in the ink tank TK can be more accurately grasped, as compared with the aspect in which the upper surface PCu of the coupling wall CN is provided at the same position as the upper surface PWu of the cylindrical partition wall WL in the Z-axis direction and the aspect in which the upper surface PCu of the coupling wall CN is provided in the upward direction from the upper surface PWu of the cylindrical partition wall WL.

### Appendix 1-5

The ink jet printer 100 according to Appendix 1-5 is the ink jet printer 100 according to Appendices 1-1 to 1-4, in which the cylindrical partition wall WL includes the upper inclined surface PWus that couples the upper surface PWu of the cylindrical partition wall WL to the outer peripheral surface PWs of the cylindrical partition wall WL and is oriented between the upper surface PWu and the outer peripheral surface PWs.

According to Appendix 1-5, even when the non-continuous portion HR caused by a scratch or the like appears in the cylindrical partition wall WL, the possibility of the capillary phenomenon in the non-continuous portion HR can be reduced and the amount of remaining ink IK in the ink tank TK can be more accurately grasped.

### Appendix 1-6

The ink jet printer 100 according to Appendix 1-6 is the ink jet printer 100 according to Appendices 1-1 to 1-5, in which the electrode rod BK includes the electrode inclined surface PBbs that couples the electrode lower surface PBb of the electrode rod BK and the electrode side surface PBs of the electrode rod BK and is oriented between the electrode lower surface PBb of the electrode rod BK and the electrode side surface PBs of the electrode rod BK.

According to Appendix 1-6, as compared with an aspect in which the electrode inclined surface PBbs is not provided in the electrode rod BK, the possibility that the state in which the ink IK and the electrode rod BK are in contact with each other is maintained when the ink liquid level distance SZ is less than the distance Hb is reduced. Therefore, according to Appendix 1-6, the amount of remaining ink IK in the ink tank TK can be more accurately grasped, as compared with an aspect in which the electrode rod BK does not have the electrode inclined surface PBbs.

### Appendix 1-7

The ink jet printer 100 according to Appendix 1-7 is the ink jet printer 100 according to Appendices 1-1 to 1-6, in which the cylindrical partition wall WL includes the lower inclined surface PWbs that couples a lower surface PWb of the cylindrical partition wall WL to an outer peripheral surface PWs of the cylindrical partition wall WL and is oriented between the lower surface PWb and the outer peripheral surface PWs.

According to Appendix 1-7, as compared with an aspect in which the cylindrical partition wall WL does not have the lower inclined surface PWbs, the possibility that the state in which the ink IK and the cylindrical partition wall WL are in contact with each other is maintained when the ink liquid level distance SZ is less than the distance HE can be reduced. Therefore, according to Appendix 1-7, as compared with the aspect in which the cylindrical partition wall WL does not have the lower inclined surface PWbs, the possibility that the state in which the electrode rod BK is in contact with the ink IK via the cylindrical partition wall WL is maintained when the ink liquid level distance SZ is less than the distance HE can be reduced. Therefore, according to Appendix 1-7, the amount of remaining ink IK in the ink tank TK can be more accurately grasped, as compared with the aspect in which the cylindrical partition wall WL does not have the lower inclined surface PWbs.

### Appendix 1-8

The ink jet printer 100 according to Appendix 1-8 is the ink jet printer 100 according to Appendices 1-1 to 1-7, in which the electrode lower surface PBb of the electrode rod BK is located between the lower surface PWb and the upper surface PWu of the cylindrical partition wall WL in the Z-axis direction, which is a extending direction of the cylindrical partition wall WL.

According to Appendix 1-8, the resistance value of the ink resistance RTb can be set to a large value, as compared with an aspect in which the lower surface PWb of the cylindrical partition wall WL is provided in an upward direction from the electrode lower surface PBb of the electrode rod BK. Therefore, according to Appendix 1-8, the change amount of the ink resistance RG in the change region A-Ru can be increased and the amount of remaining ink IK in the ink tank TK can be more accurately grasped, as compared with the aspect in which the lower surface PWb of the cylindrical partition wall WL is provided in the upward direction from the electrode lower surface PBb of the electrode rod BK.

### C. 2. Appendix 2

Hereinafter, the ink jet printer 100 according to Appendix 2 will be described.

### Appendix 2-1

The ink jet printer 100 according to Appendix 2-1 includes the ink tank TK that accommodates the ink IK, the electrode rod BK accommodated in the ink tank TK, the electrode rod BT accommodated in the ink tank TK, the cylindrical partition wall WL that is accommodated in the ink tank TK and is provided to cover at least a part of the electrode rod BK, the ink amount detection circuit 2 that is electrically coupled to the electrode rod BK and the electrode rod BT and outputs the output signal Vout according to an electric signal from one of the electrode rod BK and the electrode rod BT, and the control device 8 that specifies the amount of remaining ink IK accommodated in the ink tank TK based on the output signal Vout, in which the electrode rod BK and the electrode rod BT are disposed in the middle region AM of the ink tank TK.

According to Appendix 2-1, an electric resistance value between the electrode rod BK and the electrode rod BT is a different value in three states, that is, a state in which the ink IK accommodated in the ink tank TK is not in contact with the electrode rod BK and the electrode rod BT, a state in which the ink IK accommodated in the ink tank TK is not present above the upper opening OPu and the ink IK is in contact with the electrode rod BK and the electrode rod BT, and a state in which the ink IK accommodated in the ink tank TK is present above the upper opening OPu and the ink IK is in contact with the electrode rod BK and the electrode rod BT. Therefore, the amount of remaining ink IK accommodated in the ink tank TK can be grasped based on the electric resistance value between the electrode rod BK and the electrode rod BT.

Therefore, according to Appendix 2-1, the amount of remaining ink IK in the ink tank TK can be accurately grasped even when the ink jet printer 100 is inclined, as compared with the aspect in which the electrode rod BT and the electrode rod BK are provided in the regions different from the middle region AM.

### Appendix 2-2

The ink jet printer 100 according to Appendix 2-2 is the ink jet printer 100 according to Appendix 2-1, in which the ink tank TK includes the side wall TTy1, the side wall TTy2 facing the side wall TTy1, the side wall TTx1 coupling the side wall TTy1 and the side wall TTy2 and intersecting with the side wall TTy1, and the side wall TTx2 coupling the side wall TTy1 and the side wall TTy2 and facing the side wall TTx1, a distance between the side wall TTy1 and the side wall TTy2 is shorter than a distance between the side wall TTx1 and the side wall TTx2, and the middle region AM is located in the center region AMx including the center line Ex that is equidistant from the side wall TTx1 and the side wall TTx2.

According to Appendix 2-2, since the ink tank TK is provided in the center region AMx in a long side direction, the amount of remaining ink IK in the ink tank TK can be accurately grasped even when the ink jet printer 100 is inclined.

### Appendix 2-3

The ink jet printer 100 according to Appendix 2-3 is the ink jet printer 100 according to Appendix 2-2, in which the middle region AM is located in the center region AMy including the center line Ey that is equidistant from the side wall TTy1 and the side wall TTy2.

According to Appendix 2-3, the ink tank TK is provided in the center region AMy in a short side direction, and thus the amount of remaining ink IK in the ink tank TK can be accurately grasped even when the ink jet printer 100 is inclined in any direction.

### Appendix 2-4

The ink jet printer 100 according to Appendix 2-4 is the ink jet printer 100 according to Appendices 2-1 to 2-3, in which the control device 8 can specify whether the amount of remaining ink IK accommodated in the ink tank TK is larger than an ink amount corresponding to the distance Hb and can specify whether the amount of remaining ink IK accommodated in the ink tank TK is larger than an ink amount corresponding to the distance Hu.

As in Appendix 2-4, when the control device 8 specifies the amount of remaining ink IK accommodated in the ink tank TK at a plurality of levels, there are two risks, that is, a risk of erroneous detection due to inclination of the ink tank TK in one direction and a risk of erroneous detection due to inclination of the ink tank TK in another direction opposite to the one direction. On the other hand, in Appendix 2-4, since the ink tank TK is disposed in the middle region AM, the risk of erroneous detection can be reduced in both cases where the ink tank TK is inclined in one direction and where the ink tank TK is inclined in the other direction.

### Appendix 2-5

The ink jet printer 100 according to Appendix 2-5 is the ink jet printer 100 according to Appendices 2-1 to 2-4, in which the cylindrical partition wall WL is formed integrally with the side wall TTy2 of the ink tank TK.

According to Appendix 2-5, the number of components of the ink tank TK can be reduced, as compared with an aspect in which the cylindrical partition wall WL and the ink tank TK are separately formed.

Further, according to Appendix 2-5, accuracy of positioning the cylindrical partition wall WL with respect to the ink tank TK can be improved and detection accuracy of the amount of remaining ink IK accommodated in the ink tank TK can be improved, as compared with the aspect in which the cylindrical partition wall WL and the ink tank TK are separately formed.

### Appendix 2-6

The ink jet printer 100 according to Appendix 2-6 is the ink jet printer 100 according to Appendices 2-1 to 2-5, and includes the coupling wall CN that couples the cylindrical partition wall WL and the side wall TTy2 of the ink tank TK.

According to Appendix 2-6, the electrode rod BK covered with the cylindrical partition wall WL can be disposed near the middle region AM of the ink tank TK, as compared with the aspect in which the cylindrical partition wall WL is directly attached to the side wall TTy2. Therefore, according to Appendix 2-6, the amount of remaining ink IK in the ink tank TK can be accurately grasped even when the ink jet printer 100 is inclined.

What is claimed is:

1. A liquid ejecting apparatus comprising:
an accommodating container that accommodates a conductive liquid;
a first electrode accommodated in the accommodating container;
a second electrode accommodated in the accommodating container;
a cylindrical partition wall that is accommodated in the accommodating container and is provided to cover at least a part of the first electrode;
a detection circuitry that is electrically coupled to the first electrode and the second electrode and outputs a detection signal corresponding to an electric signal from one of the first electrode and the second electrode; and
a specifying circuitry that specifies an amount of remaining liquid accommodated in the accommodating container based on the detection signal, wherein
a first opening through which the first electrode is inserted is formed at an upper surface of the cylindrical partition wall,
a second opening is formed at a lower surface of the cylindrical partition wall, and
when the liquid accommodated in the accommodating container is present at the first opening and the second opening, the first electrode and the second electrode are in contact with the liquid accommodated in the accommodating container.

2. The liquid ejecting apparatus according to claim 1, wherein
the cylindrical partition wall is formed integrally with a side wall of the accommodating container.

3. The liquid ejecting apparatus according to claim 1, further comprising:
a coupling wall that couples the cylindrical partition wall and a side wall of the accommodating container.

4. The liquid ejecting apparatus according to claim 3, wherein
an upper surface of the coupling wall is located between the upper surface of the cylindrical partition wall and the lower surface of the cylindrical partition wall in an extending direction of the cylindrical partition wall.

5. The liquid ejecting apparatus according to claim 1, wherein
the cylindrical partition wall includes an upper inclined surface that couples the upper surface of the cylindrical partition wall and an outer surface of the cylindrical partition wall, and is oriented between the upper surface and the outer surface.

6. The liquid ejecting apparatus according to claim 1, wherein
the first electrode includes an electrode inclined surface that couples a lower surface of the first electrode and a side surface of the first electrode, and is oriented between the lower surface of the first electrode and the side surface of the first electrode.

7. The liquid ejecting apparatus according to claim 1, wherein
the cylindrical partition wall includes a lower inclined surface that couples the lower surface of the cylindrical partition wall and an outer surface of the cylindrical partition wall, and is oriented between the lower surface and the outer surface.

8. The liquid ejecting apparatus according to claim 1, wherein
a lower surface of the first electrode is located between the upper surface of the cylindrical partition wall and the lower surface of the cylindrical partition wall in an extending direction of the cylindrical partition wall.

9. A liquid accommodating device comprising:
an accommodating container that accommodates a conductive liquid;
a first electrode accommodated in the accommodating container;
a second electrode accommodated in the accommodating container;
a cylindrical partition wall that is accommodated in the accommodating container and is provided to cover at least a part of the first electrode; and
a detection circuitry that is electrically coupled to the first electrode and the second electrode and outputs a detection signal corresponding to an electric signal from one of the first electrode and the second electrode, wherein
a first opening said one electrode is formed at an upper surface of the cylindrical partition wall,
a second opening is formed at a lower surface of the cylindrical partition wall, and
when the liquid accommodated in the accommodating container is present at the first opening and the second opening, the first electrode and the second electrode are in contact with the liquid accommodated in the accommodating container.

10. The liquid accommodating device according to claim 9, wherein
the cylindrical partition wall is formed integrally with a side wall of the accommodating container.

11. The liquid accommodating device according to claim 9, further comprising:
a coupling wall that couples the cylindrical partition wall and a side wall of the accommodating container.

12. The liquid accommodating device according to claim 11, wherein
an upper surface of the coupling wall is located between the upper surface of the cylindrical partition wall and the lower surface of the cylindrical partition wall in an extending direction of the cylindrical partition wall.

13. The liquid accommodating device according to claim 9, wherein
the cylindrical partition wall includes an upper inclined surface that couples the upper surface of the cylindrical partition wall and an outer surface of the cylindrical partition wall, and is oriented between the upper surface and the outer surface.

14. The liquid accommodating device according to claim 9, wherein
the first electrode includes an electrode inclined surface that couples a lower surface of the first electrode and a side surface of the first electrode, and is oriented between the lower surface of the first electrode and the side surface of the first electrode.

15. The liquid accommodating device according to claim 9, wherein
the cylindrical partition wall includes a lower inclined surface that couples the lower surface of the cylindrical partition wall and an outer surface of the cylindrical partition wall, and is oriented between the lower surface and the outer surface.

16. The liquid accommodating device according to claim 9, wherein
a lower surface of the first electrode is located between the upper surface of the cylindrical partition wall and the lower surface of the cylindrical partition wall in an extending direction of the cylindrical partition wall.
